(19) United States
(12) Patent Application Publication
(10) Pub. No.: US 2015/0308401 A1
(43) Pub. Date: Oct. 29, 2015

(54) Apparatus, System and Method for Raising Water Using a Container

(71) Applicants: Douglas EDWARDS, (US); RE Systems, Ltd., Hove (GB)

(72) Inventor: Douglas Edwards, Hove (GB)

(21) Appl. No.: 14/648,313

(22) PCT Filed: Dec. 6, 2013
(86) PCT No.: PCT/GB2013/000530

§ 371 Date: May 29, 2015

(30) Foreign Application Priority Data
Dec. 10, 2012 (GB) 1222141.2
Nov. 5, 2013 (GB) 1319500.3

(51) Int. Cl. F03B 17/02; F03G 7/05

(52) U.S. Cl. CPC F03B 17/02; F03G 7/05

(57) ABSTRACT

An apparatus, system, and method for raising water using containers is provided. The system includes a first frame ascendable and descendible within a body of water. At least one container is connected to an elongated cable, wherein the elongated cable is connected to the first frame, wherein two free ends of the elongated cable are connectable together when the first frame is in a descended position within the body of water. The system may include an Ocean Thermal Energy Conversion (OTEC), Low-Temperature Thermal Desalination (LLTD), and/or Seawater Air Conditioning (SWAC) system, among others.

### CROSS REFERENCE TO RELATED APPLICATION

This application claims benefit of International Application No. PCT/GB2013/000530 filed Dec. 6, 2013, which claims the benefits of GB Application No. 1222141.2 filed Dec. 10, 2012 and GB Application No. 1319500.3 filed Nov. 5, 2013, the entire disclosures of which are incorporated herein by reference.

### FIELD OF THE DISCLOSURE

The present disclosure is generally related to raising water and more particularly is related to an apparatus, system, and method for raising water using a container including installation thereof.

### BACKGROUND OF THE DISCLOSURE

At present, ocean thermal energy conversion (OTEC) uses a cold water pipe to draw cold water from the deep sea, the pipe must either lie on the sea bed which is generally at least 5 miles from the land or it must be suspended. The OTEC pipe is so risky and expensive that OTEC is not commercially viable except in very ideal situations. OTEC uses the thermal difference between the warm tropical water and the cold sea water generally at least 1000 meters beneath the sea. The cold water is used in the condenser of a heat engine. The air conditioning industry also can utilize the cold water in the deep sea and it can also be used in mariculture and low temperature thermal desalination.

Thus the delivery of the cold water can be used in several different ways, and the way in which it is used and the proximity to the shore will determine the best method of importing the water. OTEC, low temperature desalination, and hydrogen production can be achieved at sea, or on land, the use of cold water in air conditioning requires for the water to be transported back to shore in most cases.

Thus, a heretofore unaddressed need exists in the industry to address the aforementioned deficiencies and inadequacies.

### SUMMARY OF THE DISCLOSURE

Embodiments of the present disclosure provide a system for raising water using containers. Briefly described, in architecture, one embodiment of the apparatus, among others, can be implemented as follows. A first frame is ascendable and descendible within a body of water. At least one container is connected to an elongated cable, wherein the elongated cable is connected to the first frame, wherein two free ends of the elongated cable are connectable together when the first frame is in a descended position within the body of water.

The present disclosure can also be viewed as providing a method of installing containers in a system for raising water. In this regard, one embodiment of such a method, among others, can be broadly summarized by the following steps: connecting at least one container to an elongated cable; connecting the elongated cable to a first frame, wherein the first frame is ascendable and descendible within a body of water; moving the first frame from an ascended position to a descended position, wherein the at least one container on the elongated cable is descended within the body of water; and connecting two free ends of the elongated cable together.

The present disclosure can also be viewed as providing a method of installing containers in an Ocean Thermal Energy Conversion (OTEC), Low-Temperature Thermal Desalination (LLTD), or Seawater Air Conditioning (SWAC) systems. In this regard, one embodiment of such a method, among others, can be broadly summarized by the following steps: connecting at least one container to an elongated cable; connecting the elongated cable to a first frame, wherein the first frame is ascendable and descendible within a body of water; moving the first frame from an ascended position to a descended position, wherein the at least one container on the elongated cable is descended within the body of water; and connecting two free ends of the elongated cable together.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of a system for raising water using containers at a first stage of installation, in accordance with a first exemplary embodiment of the present disclosure.

FIG. 2 is a schematic diagram of a system for raising water using containers at a second stage of installation, in accordance with the first exemplary embodiment of the present disclosure.

FIG. 3 is a schematic diagram of a system for raising water using containers at a third stage of installation, in accordance with the first exemplary embodiment of the present disclosure.

FIG. 4 is an isometric detailed view illustration of a system for raising water using containers at a first stage of installation, in accordance with the first exemplary embodiment of the present disclosure.

FIG. 5 is a front view illustration of a system for raising water using containers at a completed installation stage, in accordance with the first exemplary embodiment of the present disclosure.

FIG. 6 is a flowchart illustrating a method of installing containers in a system for raising water, in accordance with the first exemplary embodiment of the present disclosure.

FIG. 7 is a flowchart illustrating a method of installing containers in an Ocean Thermal Energy Conversion (OTEC), Low-Temperature Thermal Desalination (LLTD), or Seawater Air Conditioning (SWAC) systems, in accordance with the first exemplary embodiment of the present disclosure.

### DETAILED DESCRIPTION

### Key Sections and Functions

### Container;

### Shape;

A rectangular cuboid with a simple streamlined nose.

### Material.

A container made from plastic, probably EPDM or HDPE geo membrane. HDPE would be useful for storing gasoline for the sake of reducing the mass of the cold water.

### Design;

The membrane will be held around a rigid frame.

Additional beams can span its width with support columns.

The container will have a double skin with a small air pocket between the two layers for the sake of insulation and buoyancy. The air pocket could be filled with polyurethane foam. This buoyancy will partially reduce the weight of the water. The air space will compress with depth and will conveniently lose some buoyant power in the deep water.

### Feasibility

Care will need to be taken over the creating of the air space. HDPE will be unsuitable depending on the design. Creases could damage the material.

One proposed solution regardless of whether HDPE or EPDM is used for the skin;

Hoses filled with water within the cavity prevent irregular creasing within the air pocket and an additional curve can be placed over the hose, this space between the curved and the hose will be open to the sea to accommodate pressure differences and provide a contour for the membrane to form over under pressure. The exact length of membrane required to make a non-creased skin at the sea bottom is provided by curving one of the two membranes so that there is slack at the surface with low pressure rather than kinks at high pressure. Thus, the membrane will not form a pressure vessel.

As the container descends the slack allows the material to fill the gaps between the hoses precisely and smoothly. In order for this to be easy to manufacture, Polyurethane foam rather than just air is placed within the majority of these spaces. 1 cm of air or PU is sufficient to insulate the container at the surface, but the amount of insulation will change with depth due to the compression of the air.

### Container Pump;

Within the container there is a movable membrane which acts as a pump due to stored buoyancy or negative mass. The membrane passes upwards (or downwards if a weight is used rather than a buoyant force) depending on its location. The container conveniently turns 180 degrees twice during its journey once at the bottom and once at the surface. This will allow for the buoyant membrane to fill at the sea bottom and assist with the emptying of the container at the surface. The inner frame will support the membrane and the container will be split into several separate sections so that there will be more than one membrane and accompanying chamber, there can be many of these chambers. Rather than creating walled chambers the membrane itself will feature a cloth or rubber fixed around its sides. This cloth would be equal in height to the distance the membrane travelled. E.g. if the container were 5 meters high the cloth would be close to 5 meters in height on all sides. Thus, the membrane creates a sealed environment as well as a force which can suck or push fluid.

Ropes can be fixed to the container and the membrane body fitted with tubes to allow the membrane to be held in position.

The membrane itself can be nylon, EPDM or PVC. The membrane can be reinforced with a fabric similar to the type of reinforced membrane used in roofing. Alternatively reinforcing measure could simply involve the addition of high denier cloth to key areas of the membrane rather than the whole membrane.

### Design

The membrane pump is really a rectangular cuboid container filled with gasoline or metal or concrete weights. This container will be made in the same way as a rigid MDPE/HDPE water container. The weighted element is joined to a frame which also comprises a fabric. The fabric separates the two sides of the membrane and eliminates the need to the membrane pump ‘piston’ to create the seal. The fabric shape is like a cube with one side missing. When the container is full of fresh cold water the fabric will be taut, by the time the container has emptied the fabric will be compressed/folded. In order to keep the fold neat the use of bungee cords will create a series of deliberate folds in the cloth rather than chaotic ones. The cloth can feature a double layer of cloth (preferably NYLON or EPDM rubber) with insulation material or air in the middle cavity.

The membrane will be guided up and down using metal tubes joined to the membrane frame which pass along ropes to the sides of the frame.

Catches can prevent the container from moving once filled or empty until they are released. The catches can be triggered simultaneously using pulleys and ropes connecting the movement of one catch to at least one other.

### Container Extraction Valve;

The valve must pass the extractor in motion and for a close enough seal for there to be little or no warm water contamination. The container passes the extractor valve in motion and a seal is made between two interacting sealing surfaces. A T element interacts with a pair of L shapes (One of the L sections flat surface direction is reversed so that the T slots between a pair of L shapes, either the T slots between two L shapes or the upper flat section of the T sit on the L horizontal section.

A pair of interacting sealing surfaces must be provided, one on the container and the other on the extractor. The two surfaces press on one another creating a seal as the container moves along the extractor.

The container and extractor will require a valve system. The proposed valve system will be similar in design to non-return Louvre shutters except that additional care will be taken to ensure that they are fully sealed and each shutter/flap will be fitted with a spring or elastic band to make a tight seal.

The flaps of the Louvre system will be fitted with springs or rubber bands which open due to the force of the water against the springs, the springs will close the flaps when the pressure of the membrane ceases. An additional catch will prevent the flaps from opening early as the container must travel flat for a period before emptying. This flap will resist the power of the membrane and will be forced down by the extractor and the motion of the container at the right time. For example a catch can prevent a bar from lifting which covers all of the flaps. Once the catch is released the bar can lift, allowing the flaps to open. Alternatively catches on the membrane within the container will prevent the membrane from moving until the right time (see later on in description).

The flaps of the container and extractor are place sufficiently below the interactive sealing surfaces so that they can open without hampering the interacting surfaces of the container and extractor.

The sides of the valves should be high enough to ensure that the flaps are given space to open. As the container interacts with the extractor, the container must be able to pass with its flaps open.

The flaps themselves can have a low density PU cover which, when the flaps are opening, will compress. In order to make the compression efficient each flap will open into a rigid wall which spans the flap thus the PU will compress into the wall rather than impeding the flow through the adjacent flap. The PU will prevent excess warm water intake due to the raise wall requirement for this design.

The container vents are held within a streamlined frame which allows the vents to open and for the sake of providing a surface on all sides of the enclosed vents for the extractor to interact with. The nose and tail as well as the sides of this frame will feature flat areas which will allow for the container and extractor to form a seal.

The extractor flaps will be held below a sheet, preferably plastic, which is cut in such a way that it appears to be like a ladder, with a series of rungs and cut away sections (the water passes through the cut away sections). The surfaces of the ladder are flat. Each flat ‘rung’ surface allows for the flat surfaces on the nose and tail of the container vent frame to constantly be meeting with at least one of these ‘rungs’ on the extractor. Thus a seal is made. The container frame always touches the vertical elements of the ‘ladder’ on the extractor vent and the nose and tail always touch the rungs, in doing so it makes a constant seal to its front and sides. Preferably the flat surfaces of the container would always be covering 2-3 rungs so that there is little chance of a leak.

Additional flat surfaces on the nose and tail of the extractor vent feature additional flat surfaces which are as long and wide as an entire set of vents on the container. Thus the nose and tail flat surfaces of the container vent frame are in contact with the extractor flat surface prior to the releasing of the membrane within the container. When in operation and once releasing the cold water, the flat surfaces of the container vent frame will either be covering at least one rung of the extractor vent or the flat surfaces at the nose and tail of the extractor frame.

In order to make the system work with little friction, the container or extractor will comprise compressible polyurethane members which will compress. Air pockets or rubber members are also possible. Preferably the PU will be covered with HDPE or NYLON which will lower the friction.

The container itself can be positioned carefully as it interacts with the extractor by using castor wheels, or gravity rollers, to support the container. Assuming the castor wheels are on the container, the wheels pass between a pair of right angles surfaces so that the container is held in a certain trajectory. Alternatively, the extractor can feature gravity rollers and the container raised sections which pass through the gravity rollers in the same way as the castors. Preferably the gravity roller system has raised sides to guide the container. This system will control the height and trajectory of the container.

Gravity roller or castor systems on the top and bottom of the container would fix the position of the container very precisely. This guide system can make it easier for the two elements to meet by adding wider elements to the rail system at the rail origin.

Sealing principle;

In principle, in order to make a seal between the container and the extractor, the extractor container system has the flowing features;
1 The noses and tails of the container valves feature flat areas which cover at least one ‘rung’ on the extractor.
2 The extractor features a flat area, at its nose and tail. This area is as wide as the entire set of container flaps and as long. The rear end container vent frame fully covers this area before releasing the cold water and by the time the nose of the container vent frame has passed this area at the end of the extractor the rear end of the container vent frame will be in contact with this area so that no water could have escaped out of the front.
3 The T and double L of the extractor/container valve seal system prevents water escaping to the sides and/or the ‘Ladder sides’ of the extractor interact with the members joined to the container vent frame.
4 The container, extractor system features at least one subsystem capable of either preventing the flaps on the container from opening or preventing the membrane within the container from moving until the desired moment. This moment occurs when the container valve is completely covered by the flat surfaces on the extractor.

The combination of 1, 2, and 3 and 4 will create a seal at all times in the container extractor interaction

### Note

This extraction system feature 2 will allow some warm water to be trapped within the seal of the system as the container passes. Waste cold water could be sprayed across the exposed underside of the extract to reduce the extent of the contamination.

### Extractor Frame and Rope Frame;

Simple rectangular cuboid structure made from I beam and columns Supported at several places along the length and preferably with the frame streamlined and with the weight of each beam neutralised locally.

### Design;

Simply, bolted I beams and columns, no column in the middle.

In order to ensure the containers are stable;

A second conveyor will pass underneath and to the sides of the containers to support them.

An additional rail interface (besides the extractor and container valve) between the container and the extractor or frame will prevent lateral movement.

### Buoyancy

The frame can be fitted with floats on its lower side as per a semi-submersible offshore platform this can allow the frame to be transported to site as though it were a boat.

The frame may comprise at least one ‘boat’ that is more than one boat is transported from shore, then joined either under the water or at the surface on site.

### Novel Aspect to the Upper Frame

The buoyant floats will each preferably be fitted with a hinge at one end so that once underwater they can fold down so that their ends are in deeper water. This system can be manipulated using a Hydraulic system or a rope rigging system.

The lower ends of the articulated limbs will preferably either; join to horizontal ropes which in turn join to the outer vertical ropes (this may make it possible to reduce the no. of vertical ropes). Alternatively, if conventional methods are required, a catenary mooring system.

### Louvre Modifications List;

The Louvre flaps are fitted with springs, rubber elastic or an air filled compressible/expansible resistive chamber.

The Louvre flaps are coated in rubber, hdpe, emdm.

The outer side of the extractor Louvre are broken up into with non-valve sections which are at least equal in height to the opening of their flaps. The top of this section would be slightly compressible.

The ends and sides of all louvre systems must have sides which are greater in height to the Louvre flaps.

The outer side of the extractor Louvre are broken up into with non-valve sections which are at least equal in height to the opening of their flaps the top of this section would be slightly compressible, this prevents water from flowing out along the length of the extractor.

The nose and tail of the Louvre system must feature a flat area (no valve) equal in length to the length of a single set of louvres.

### Catch on Lower Extractor Container;

The lower extractor features a catch which is pushed down by the nose of the container valve. See lower extractor flap.

Trip Switches and Separate Compartments within the Extractors;

The trip switch triggers a pump once depressed by the container so that the movement of water is assisted by power from within the extractors. This could also be achieved by storing local potential energy with weighted or buoyant membranes and/or pressured pistons compressing air.

### Extractor Seal

In order to make a pressurised seal with the container the extractor surfaces which are brought into contact with the container valve will feature a pocket of either water (with a resisting expansible chamber valve to allow a change in volume but with resistance APPARATUS, SYSTEM AND METHOD FOR RAISING WATER USING A CONTAINER

### CROSS REFERENCE TO RELATED APPLICATION

This application claims benefit of International Application No. PCT/GB2013/000530 filed Dec. 6, 2013, which claims the benefits of GB Application No. 1222141.2 filed Dec. 10, 2012 and GB Application No. 1319500.3 filed Nov. 5, 2013, the entire disclosures of which are incorporated herein by reference.

### FIELD OF THE DISCLOSURE

The present disclosure is generally related to raising water and more particularly is related to an apparatus, system, and method for raising water using a container including installation thereof.

### BACKGROUND OF THE DISCLOSURE

At present, ocean thermal energy conversion (OTEC) uses a cold water pipe to draw cold water from the deep sea, the pipe must either lie on the sea bed which is generally at least 5 miles from the land or it must be suspended. The OTEC pipe is so risky and expensive that OTEC is not commercially viable except in very ideal situations. OTEC uses the thermal difference between the warm tropical water and the cold sea water generally at least 1000 meters beneath the sea. The cold water is used in the condenser of a heat engine. The air conditioning industry also can utilize the cold water in the deep sea and it can also be used in mariculture and low temperature thermal desalination.

Thus the delivery of the cold water can be used in several different ways, and the way in which it is used and the proximity to the shore will determine the best method of importing the water. OTEC, low temperature desalination, and hydrogen production can be achieved at sea, or on land, the use of cold water in air conditioning requires for the water to be transported back to shore in most cases.

Thus, a heretofore unaddressed need exists in the industry to address the aforementioned deficiencies and inadequacies.

### SUMMARY OF THE DISCLOSURE

Embodiments of the present disclosure provide a system for raising water using containers. Briefly described, in architecture, one embodiment of the apparatus, among others, can be implemented as follows. A first frame is ascendable and descendible within a body of water. At least one container is connected to an elongated cable, wherein the elongated cable is connected to the first frame, wherein two free ends of the elongated cable are connectable together when the first frame is in a descended position within the body of water.

The present disclosure can also be viewed as providing a method of installing containers in a system for raising water. In this regard, one embodiment of such a method, among others, can be broadly summarized by the following steps: connecting at least one container to an elongated cable; connecting the elongated cable to a first frame, wherein the first frame is ascendable and descendible within a body of water; moving the first frame from an ascended position to a descended position, wherein the at least one container on the elongated cable is descended within the body of water; and connecting two free ends of the elongated cable together.

The present disclosure can also be viewed as providing a method of installing containers in an Ocean Thermal Energy Conversion (OTEC), Low-Temperature Thermal Desalination (LLTD), or Seawater Air Conditioning (SWAC) systems. In this regard, one embodiment of such a method, among others, can be broadly summarized by the following steps: connecting at least one container to an elongated cable; connecting the elongated cable to a first frame, wherein the first frame is ascendable and descendible within a body of water; moving the first frame from an ascended position to a descended position, wherein the at least one container on the elongated cable is descended within the body of water; and connecting two free ends of the elongated cable together.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

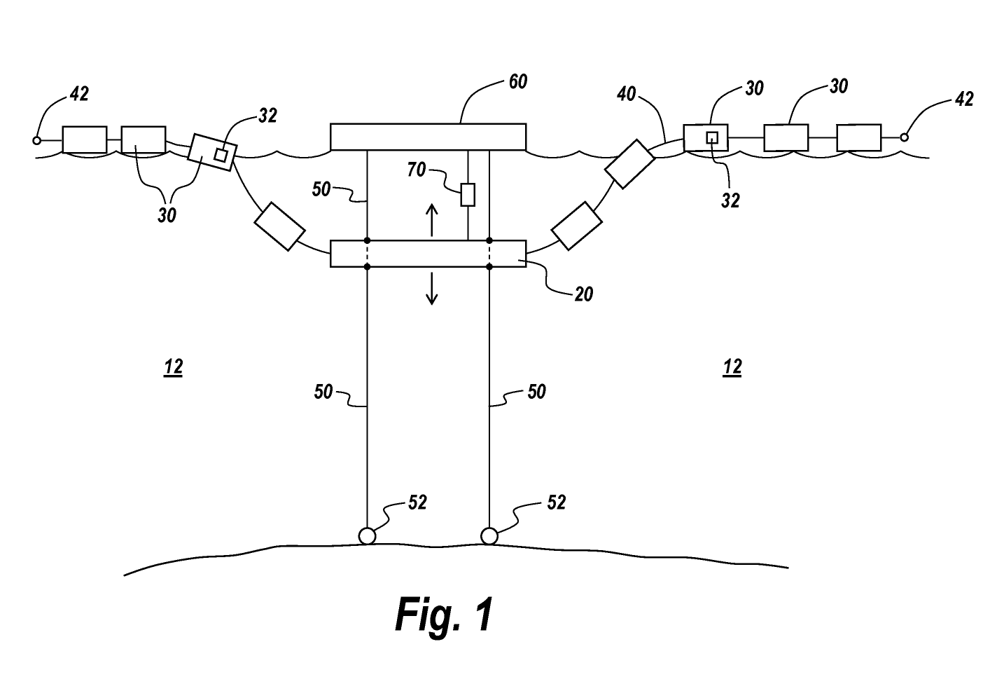

FIG. 1 is a schematic diagram of a system for raising water using containers at a first stage of installation, in accordance with a first exemplary embodiment of the present disclosure.

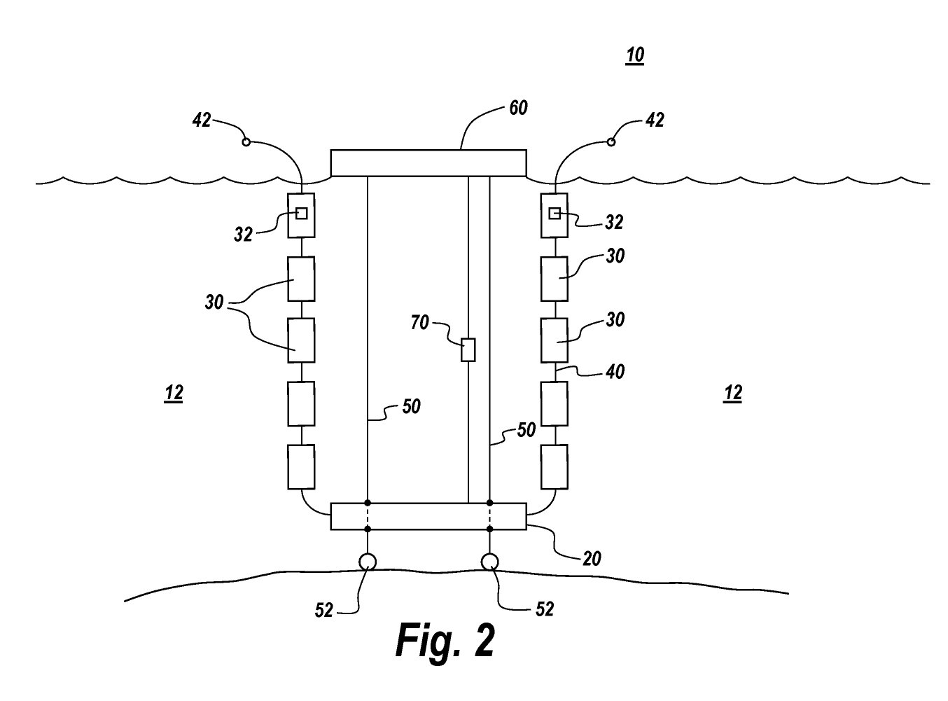

FIG. 2 is a schematic diagram of a system for raising water using containers at a second stage of installation, in accordance with the first exemplary embodiment of the present disclosure.

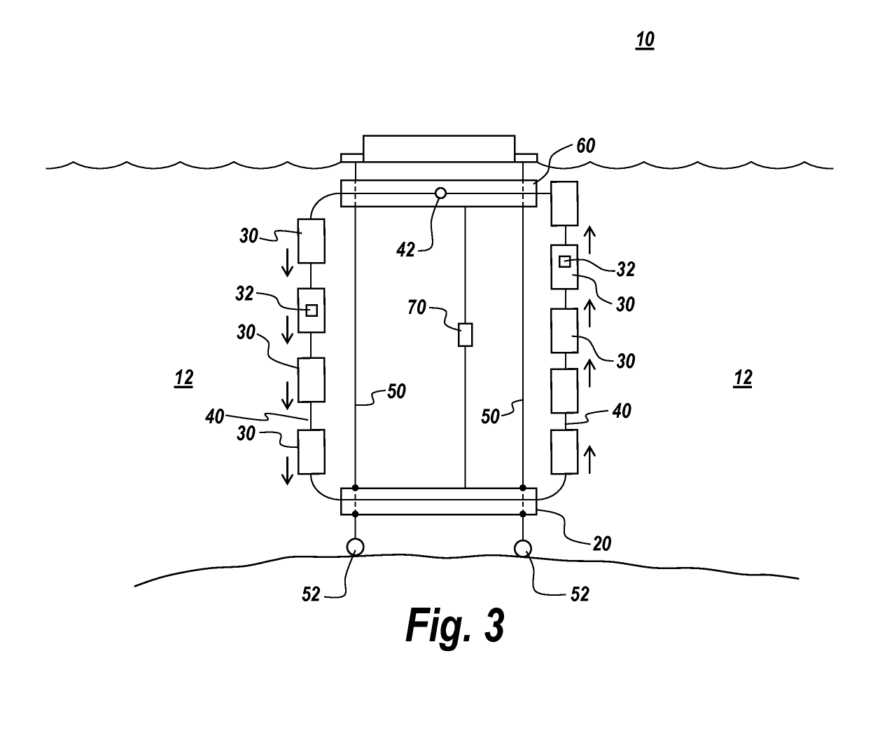

FIG. 3 is a schematic diagram of a system for raising water using containers at a third stage of installation, in accordance with the first exemplary embodiment of the present disclosure.

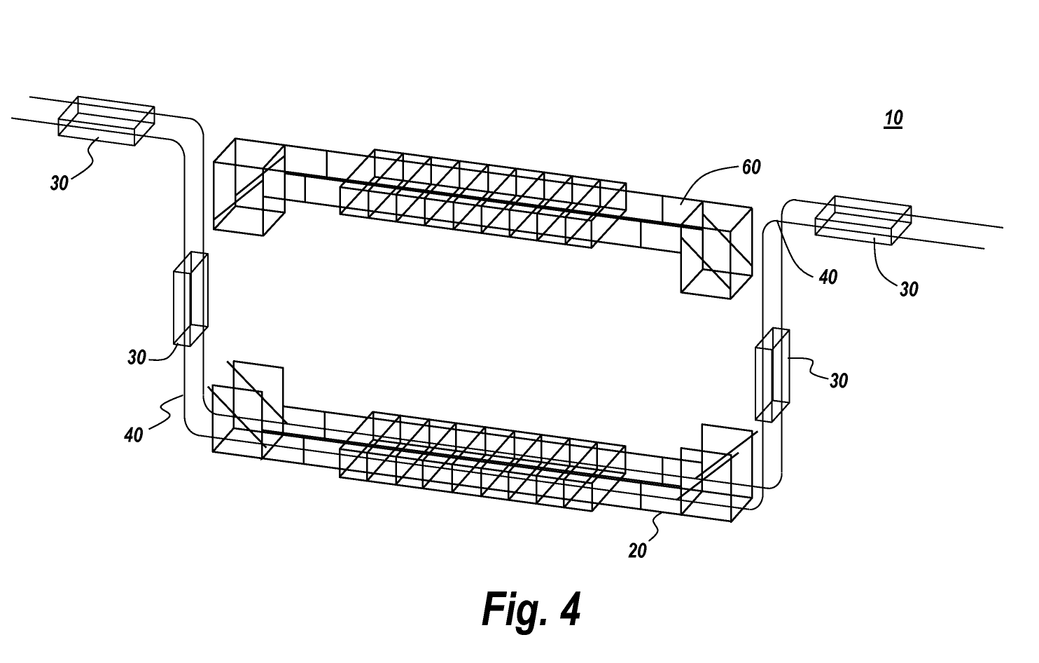

FIG. 4 is an isometric detailed view illustration of a system for raising water using containers at a first stage of installation, in accordance with the first exemplary embodiment of the present disclosure.

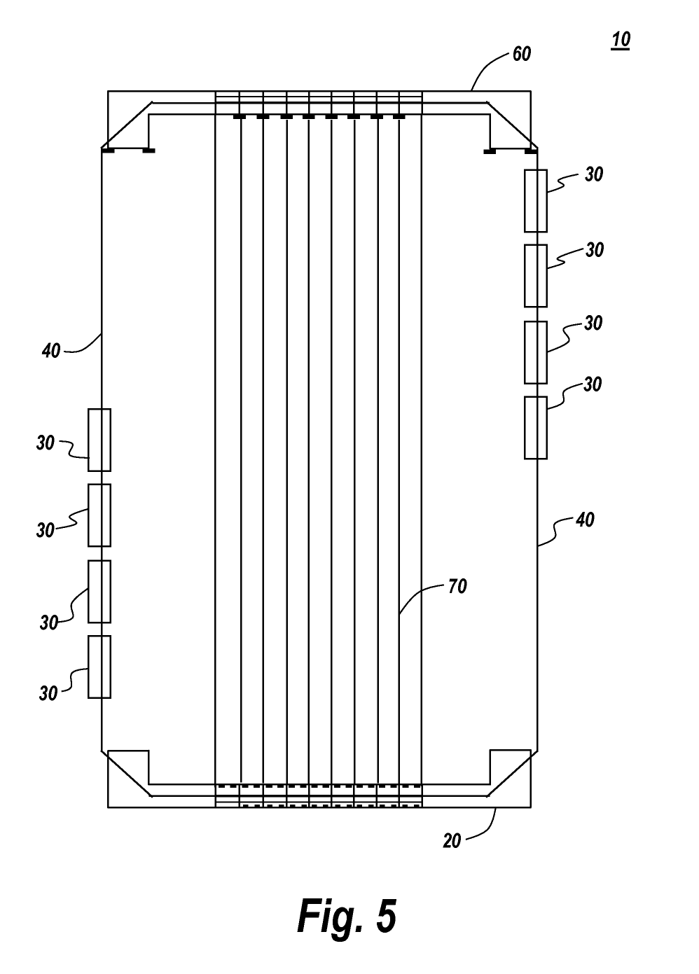

FIG. 5 is a front view illustration of a system for raising water using containers at a completed installation stage, in accordance with the first exemplary embodiment of the present disclosure.

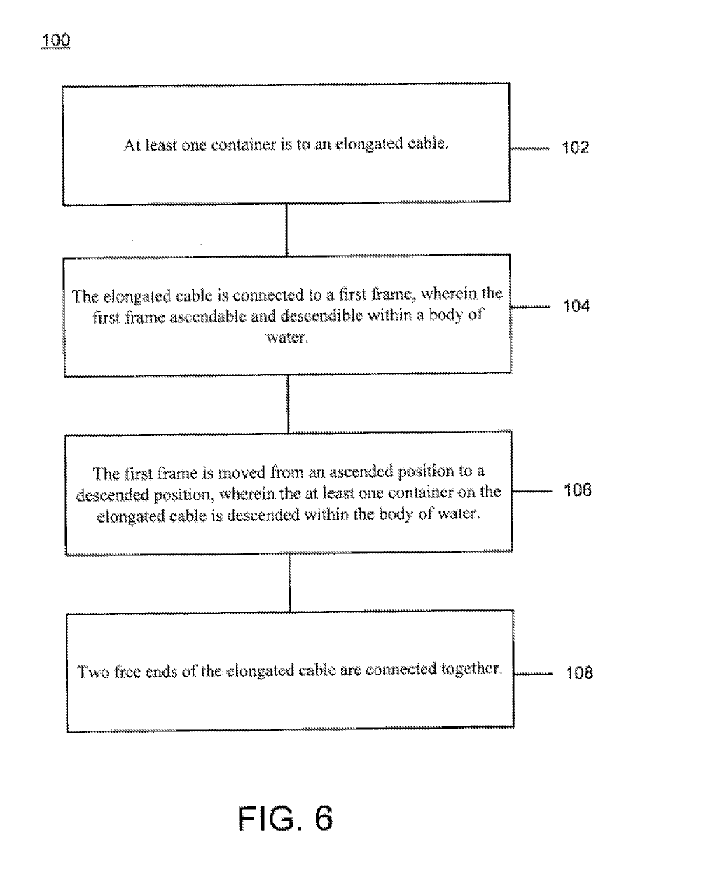

FIG. 6 is a flowchart illustrating a method of installing containers in a system for raising water, in accordance with the first exemplary embodiment of the present disclosure.

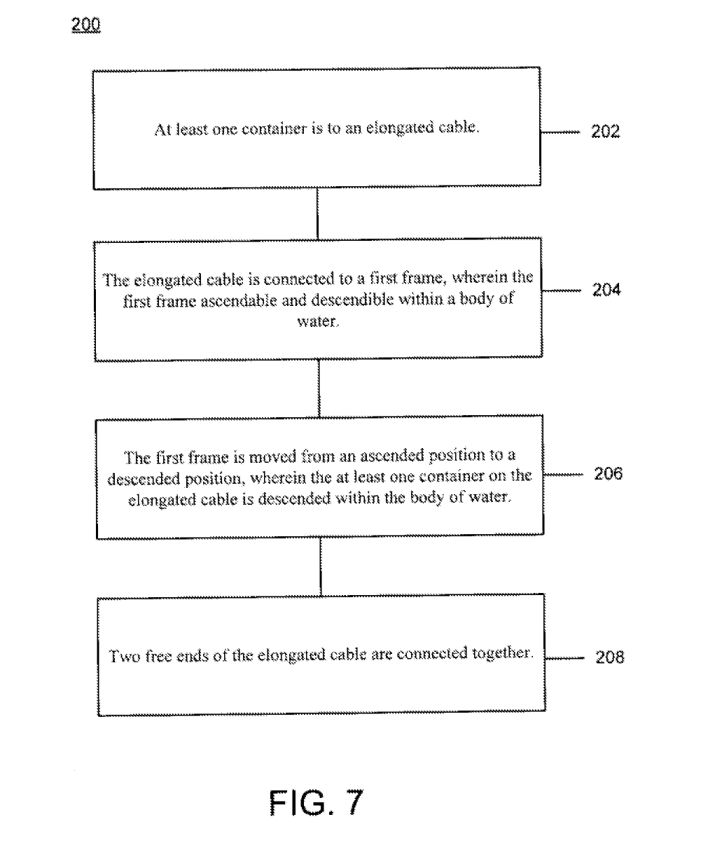

FIG. 7 is a flowchart illustrating a method of installing containers in an Ocean Thermal Energy Conversion (OTEC), Low-Temperature Thermal Desalination (LLTD), or Seawater Air Conditioning (SWAC) systems, in accordance with the first exemplary embodiment of the present disclosure.

### DETAILED DESCRIPTION

Key sections and functions;

### Container;

### Shape;

A rectangular cuboid with a simple streamlined nose.

### Material.

A container made from plastic, probably EPDM or HDPE geo membrane. HDPE would be useful for storing gasoline for the sake of reducing the mass of the cold water.

### Design;

The membrane will be held around a rigid frame.

Additional beams can span its width with support columns

The container will have a double skin with a small air pocket between the two layers for the sake of insulation and buoyancy. The air pocket could be filled with polyurethane foam. This buoyancy will partially reduce the weight of the water. The air space will compress with depth and will conveniently lose some buoyant power in the deep water.

### Feasibility

Care will need to be taken over the creating of the air space. HDPE will be unsuitable depending on the design. Creases could damage the material.

One proposed solution regardless of whether HDPE or EPDM is used for the skin;

Hoses filled with water within the cavity prevent irregular creasing within the air pocket and an additional curve can be placed over the hose, this space between the curved and the hose will be open to the sea to accommodate pressure differences and provide a contour for the membrane to form over under pressure. The exact length of membrane required to make a non-creased skin at the sea bottom is provided by curving one of the two membranes so that there is slack at the surface with low pressure rather than kinks at high pressure. Thus, the membrane will not form a pressure vessel.

As the container descends the slack allows the material to fill the gaps between the hoses precisely and smoothly. In order for this to be easy to manufacture, Polyurethane foam rather than just air is placed within the majority of these spaces. 1 cm of air or PU is sufficient to insulate the container at the surface, but the amount of insulation will change with depth due to the compression of the air.

### Container Pump;

Within the container there is a movable membrane which acts as a pump due to stored buoyancy or negative mass. The membrane passes upwards (or downwards if a weight is used rather than a buoyant force) depending on its location. The container conveniently turns 180 degrees twice during its journey once at the bottom and once at the surface. This will allow for the buoyant membrane to fill at the sea bottom and assist with the emptying of the container at the surface. The inner frame will support the membrane and the container will be split into several separate sections so that there will be more than one membrane and accompanying chamber, there can be many of these chambers. Rather than creating walled chambers the membrane itself will feature a cloth or rubber fixed around its sides. This cloth would be equal in height to the distance the membrane travelled. E.g. if the container were 5 meters high the cloth would be close to 5 meters in height on all sides. Thus, the membrane creates a sealed environment as well as a force which can suck or push fluid.

Ropes can be fixed to the container and the membrane body fitted with tubes to allow the membrane to be held in position.

The membrane itself can be nylon, EPDM or PVC. The membrane can be reinforced with a fabric similar to the type of reinforced membrane used in roofing. Alternatively reinforcing measure could simply involve the addition of high denier cloth to key areas of the membrane rather than the whole membrane.

### Design

The membrane pump is really a rectangular cuboid container filled with gasoline or metal or concrete weights. This container will be made in the same way as a rigid MDPE/HDPE water container. The weighted element is joined to a frame which also comprises a fabric. The fabric separates the two sides of the membrane and eliminates the need to the membrane pump ‘piston’ to create the seal. The fabric shape is like a cube with one side missing. When the container is full of fresh cold water the fabric will be taut, by the time the container has emptied the fabric will be compressed/folded. In order to keep the fold neat the use of bungee cords will create a series of deliberate folds in the cloth rather than chaotic ones. The cloth can feature a double layer of cloth (preferably NYLON or EPDM rubber) with insulation material or air in the middle cavity.

The membrane will be guided up and down using metal tubes joined to the membrane frame which pass along ropes to the sides of the frame.

Catches can prevent the container from moving once filled or empty until they are released. The catches can be triggered simultaneously using pulleys and ropes connecting the movement of one catch to at least one other.

### Container Extraction Valve;

The valve must pass the extractor in motion and for a close enough seal for there to be little or no warm water contamination. The container passes the extractor valve in motion and a seal is made between two interacting sealing surfaces. A T element interacts with a pair of L shapes (One of the L sections flat surface direction is reversed so that the T slots between a pair of L shapes, either the T slots between two L shapes or the upper flat section of the T sit on the L horizontal section.

A pair of interacting sealing surfaces must be provided, one on the container and the other on the extractor. The two surfaces press on one another creating a seal as the container moves along the extractor.

The container and extractor will require a valve system. The proposed valve system will be similar in design to non-return Louvre shutters except that additional care will be taken to ensure that they are fully sealed and each shutter/flap will be fitted with a spring or elastic band to make a tight seal.

The flaps of the Louvre system will be fitted with springs or rubber bands which open due to the force of the water against the springs, the springs will close the flaps when the pressure of the membrane ceases. An additional catch will prevent the flaps from opening early as the container must travel flat for a period before emptying. This flap will resist the power of the membrane and will be forced down by the extractor and the motion of the container at the right time. For example a catch can prevent a bar from lifting which covers all of the flaps. Once the catch is released the bar can lift, allowing the flaps to open. Alternatively catches on the membrane within the container will prevent the membrane from moving until the right time (see later on in description).

The flaps of the container and extractor are place sufficiently below the interactive sealing surfaces so that they can open without hampering the interacting surfaces of the container and extractor.

The sides of the valves should be high enough to ensure that the flaps are given space to open. As the container interacts with the extractor, the container must be able to pass with its flaps open.

The flaps themselves can have a low density PU cover which, when the flaps are opening, will compress. In order to make the compression efficient each flap will open into a rigid wall which spans the flap thus the PU will compress into the wall rather than impeding the flow through the adjacent flap. The PU will prevent excess warm water intake due to the raise wall requirement for this design.

The container vents are held within a streamlined frame which allows the vents to open and for the sake of providing a surface on all sides of the enclosed vents for the extractor to interact with. The nose and tail as well as the sides of this frame will feature flat areas which will allow for the container and extractor to form a seal. The extractor flaps will be held below a sheet, preferably plastic, which is cut in such a way that it appears to be like a ladder, with a series of rungs and cut away sections (the water passes through the cut away sections). The surfaces of the ladder are flat. Each flat ‘rung’ surface allows for the flat surfaces on the nose and tail of the container vent frame to constantly be meeting with at least one of these ‘rungs’ on the extractor. Thus a seal is made. The container frame always touches the vertical elements of the ‘ladder’ on the extractor vent and the nose and tail always touch the rungs, in doing so it makes a constant seal to its front and sides. Preferably the flat surfaces of the container would always be covering 2-3 rungs so that there is little chance of a leak.

Additional flat surfaces on the nose and tail of the extractor vent feature additional flat surfaces which are as long and wide as an entire set of vents on the container. Thus the nose and tail flat surfaces of the container vent frame are in contact with the extractor flat surface prior to the releasing of the membrane within the container. When in operation and once releasing the cold water, the flat surfaces of the container vent frame will either be covering at least one rung of the extractor vent or the flat surfaces at the nose and tail of the extractor frame.

In order to make the system work with little friction, the container or extractor will comprise compressible polyurethane members which will compress. Air pockets or rubber members are also possible. Preferably the PU will be covered with HDPE or NYLON which will lower the friction.

The container itself can be positioned carefully as it interacts with the extractor by using castor wheels, or gravity rollers, to support the container. Assuming the castor wheels are on the container, the wheels pass between a pair of right angles surfaces so that the container is held in a certain trajectory. Alternatively, the extractor can feature gravity rollers and the container raised sections which pass through the gravity rollers in the same way as the castors. Preferably the gravity roller system has raised sides to guide the container. This system will control the height and trajectory of the container.

Gravity roller or castor systems on the top and bottom of the container would fix the position of the container very precisely. This guide system can make it easier for the two elements to meet by adding wider elements to the rail system at the rail origin.

### Sealing Principle;

In principle, in order to make a seal between the container and the extractor, the extractor container system has the flowing features;
5 The noses and tails of the container valves feature flat areas which cover at least one ‘rung’ on the extractor.
6 The extractor features a flat area, at its nose and tail. This area is as wide as the entire set of container flaps and as long. The rear end container vent frame fully covers this area before releasing the cold water and by the time the nose of the container vent frame has passed this area at the end of the extractor the rear end of the container vent frame will be in contact with this area so that no water could have escaped out of the front.
7 The T and double L of the extractor/container valve seal system prevents water escaping to the sides and/or the ‘Ladder sides’ of the extractor interact with the members joined to the container vent frame.
8 The container, extractor system features at least one subsystem capable of either preventing the flaps on the container from opening or preventing the membrane within the container from moving until the desired moment. This moment occurs when the container valve is completely covered by the flat surfaces on the extractor.

The combination of 1, 2, and 3 and 4 will create a seal at all times in the container extractor interaction

### Note

This extraction system feature 2 will allow some warm water to be trapped within the seal of the system as the container passes. Waste cold water could be sprayed across the exposed underside of the extract to reduce the extent of the contamination.

### Extractor Frame and Rope Frame;

Simple rectangular cuboid structure made from I beam and columns Supported at several places along the length and preferably with the frame streamlined and with the weight of each beam neutralised locally.

### Design;

Simply, bolted I beams and columns, no column in the middle.

In order to ensure the containers are stable;

A second conveyor will pass underneath and to the sides of the containers to support them.

An additional rail interface (besides the extractor and container valve) between the container and the extractor or frame will prevent lateral movement.

### Buoyancy

The frame can be fitted with floats on its lower side as per a semi-submersible offshore platform this can allow the frame to be transported to site as though it were a boat.

The frame may comprise at least one ‘boat’ that is more than one boat is transported from shore, then joined either under the water or at the surface on site.

### Novel Aspect to the Upper Frame

The buoyant floats will each preferably be fitted with a hinge at one end so that once underwater they can fold down so that their ends are in deeper water. This system can be manipulated using a Hydraulic system or a rope rigging system.

The lower ends of the articulated limbs will preferably either; join to horizontal ropes which in turn join to the outer vertical ropes (this may make it possible to reduce the no. of vertical ropes). Alternatively, if conventional methods are required, a catenary mooring system.

### Louvre Modifications List;

The Louvre flaps are fitted with springs, rubber elastic or an air filled compressible/expansible resistive chamber.

The Louvre flaps are coated in rubber, hdpe, emdm.

The outer side of the extractor Louvre are broken up into with non-valve sections which are at least equal in height to the opening of their flaps. The top of this section would be slightly compressible.

The ends and sides of all louvre systems must have sides which are greater in height to the Louvre flaps.

The outer side of the extractor Louvre are broken up into with non-valve sections which are at least equal in height to the opening of their flaps the top of this section would be slightly compressible, this prevents water from flowing out along the length of the extractor.

The nose and tail of the Louvre system must feature a flat area (no valve) equal in length to the length of a single set of louvres.

### Catch on Lower Extractor Container;

The lower extractor features a catch which is pushed down by the nose of the container valve. See lower extractor flap.

Trip Switches and Separate Compartments within the Extractors;

The trip switch triggers a pump once depressed by the container so that the movement of water is assisted by power from within the extractors. This could also be achieved by storing local potential energy with weighted or buoyant membranes and/or pressured pistons compressing air.

### Extractor Seal

In order to make a pressurised seal with the container the extractor surfaces which are brought into contact with the container valve will feature a pocket of either water (with a resisting expansible chamber valve to allow a change in volume but with resistance) or air within a double layer of geo membrane. Additional HDPE membrane can be held over the top to lower friction.

### Overall Function

As the container reaches the surface, the membrane within the container will push upwards, this force is prevented from opening the valve on the container by a flap on the rear end of the container valve, until the container and the extractor have fitted together. Once this catch is released the membrane will force the container flaps open and the water will force its way into the extractor through the extractor valve.

Once the container membrane has moved to the top the valves will close.

Depending on the scale of the system a container which can vary in size will be required.

In order to accommodate more extractor length additional upper frame and extractor can be added.

### Wheel System

The method with which the ropes and containers are directed;

### Design

Preferably using rollers similar to those used in gravity conveyors. Additional sophistication can be included such as suspension, bearings and a conveyor roller with conveyor belt.

Preferably an additional rope held between the pair of driving ropes, is passed through a rigid tube held closely to the ropes at each end, this will keep the ropes together and prevent them from moving apart or together. The subsequent maximum possible ‘deflection’ of the driving rope is less than the deflection which would cause the ropes to pass over the rotating surfaces. As a result derailing is not possible.

Other options include;

A raised edge at the side of the turning point prevent the rope from derailing.

### Rope Driving System

One method of driving the ropes will include the following; a gravity roller conveyor, a driven rope, at least one wheel placed on top of the rope so that it is trapped between the conveyor and the wheel. The width of the conveyor will be large enough to allow the wheel to be placed partially with the roller conveyor so as to prevent derailing. Preferably the wheel has a pneumatic tyre and is fitted with suspension. This is an important innovation because a system using this design will be less vulnerable to wave motion and will not require any traction to be generated on the ‘turning points’.

### Container to Rope Attachment

The container holds a tube at the front and back which is held through at least one bearing; for example a Plummer block. The end the tube joins to the rope, this can be achieved using at least one piece of ‘angle’ which is joined to the tube preferably using a piece of ‘flat’ which has been welded to the tube. The flat section will protrude slightly from the tube and then the flat can be joined to it. The angle section can join to the flat using one of its surfaces and can be placed to the side of the rope with the other. An additional piece of flat or angle can be placed on the other side and bolted to the original angle section. The use of angle is convenient because the angle section height can be little more or even less than the rope diameter this prevent the wheel driving the rope from having to change height dramatically at all. The front end of the angle (i.e. the angles ‘side’/thickness which would be a vertical right angle without cutting) can be cut to include an angle to allow the wheel to rise gradually over the attachment. Preferably the angle sections would include countersunk bolt holes for the bolts. The rope can be prevented from coming off the conveyor and upper turning points by placing an upper surface over the conveyor, this surface will create a space between the conveyor and itself which will be large enough to allow the flat section mentioned above which is protruding from the tube to pass but not allow the rope to pass due to differences in diameter. All of the conveyer will have raised sides as well.

The lower turning points can have a mechanism for preventing the ‘de railing’ of the rope. Assuming the rope is on the underside of the lower turning point, a lever which can be pulled from the surface would allow for a turning point to be pulled upwards once the lever had been pulled back. When in place a surface connected to the lever would prevent the rope from coming off as the space between it and the conveyor would be too small for the rope to pass but it would allow the container to rope attachment to pass. The lever could be controlled from the surface and would preferable have a spring or second rope system. A pulley system would be used so that the rope could be pulled up from the surface but the lever would be pulled down.

### Location of Turning Points;

Ropes passing from sea surface to sea bottom will create a fixing point for turning points. These ropes will be supported from the surface with buoyancy. The ropes for all/any of the turning points will be joined to a single weighted rope at the sea bottom and preferably a single rope with buoyancy at the sea surface. A rigid frame at the surface and sea bottom may also be useful. A gentle turning circle for a container will be achieved.

Many variations are possible, with different buoyancy location options, including the use of buoyancy in a plurality of different locations for each turning point including different depths, buoyancy and weights on ropes with pulleys, buoyant piles to prevent the turning point from moving due to waves etc.

The turning point will comprise at least one tube joined to a surface which holds the turning/rotating system surface (e.g. a conveyor). The tube allows the vertical ropes to pass through it joining the turning points to the vertical ropes. Hence, a turning point can be lowered and raised along the vertical ropes.

The wheel can be mechanically driven up and down the rope pair using by an additional rope preferably with the use of at least one pulley. The turning point can also store its own buoyancy. Buoyancy can be used to lessen any deflection. Thus the wheel can be raised to the surface for maintenance. A rope system used to drive the turning point would incorporate a pulley which is joined to the single rope mentioned at the sea bottom or joined to the bottom of the rope pairs. The turning point is at least partially supported by this rope.

A pair of turning points on either side of the container at the same height) can be joined using at least one horizontal bar, I beam, length of angle etc. (so there is really one turning point which comprises the left and right turning point). A person skilled in the trade of designing supporting surfaces etc. can advise. This also ensures that the vertical ropes are held the right space apart at all times.

In order to push the vertical rope pairs outward, a permanent frame could be placed at the bottom of this frame which would have no moving parts and would only serve to spread the ropes from the lower single rope to the correct width apart. The pulley rope would pass through a loop hole on this frame which is placed directly below a fixing on the turning point so as to create a vertical pulling force rather than one which was skewed due to the difference in position between the single lower rope and the spacing of the ropes above. The pulley rope can be moved from the surface. The turning point would have two attachments for the pulley rope, one above and one below, thus the turning points can be held in a controlled position.

The turning point may not have any rotating surface if it is supported by a rigid rope, chain etc. This is true in the case of a system which uses self-propelled containers. Instead the container attachment would be fitted with a small groove, less than the diameter or the rigid rope so that it can pass along the rigid rope but not come off it, the groove would also allow the rope to pass the turning point as the joint between the rigid rope and the turning point would be small enough to allow the container attachment to pass.

### Buoyancy;

### To Support the Structure;

### Design;

A double layer of HDPE geo membrane built around a frame with the middle cavity preferably filled with concrete or foamed concrete for perfection. The inner air space can contain an air bag and the concrete outer layer will have an opening between the inside and the outside. Thus the inner chamber can fill with water and air can be passed in and out of the air bag to change buoyancy.

This will prevent puncture for long term use.

The buoyancy can then be held in a framework to distribute the loads.

This can also be used to neutralise the weight of the ‘I beams’ and streamline them against currents and also for the deep water mooring system.

Buoyancy for the additional ropes can be created in the same way, preferably with a proportion of the buoyancy being stored at a significant depth below sea level. If the horizontal rope method is used the horizontal rope will join below the buoyancy.

### Additional Rope Driving Systems;

To drive the rope system;

Several choices;
1 At least one set of wheels on either side each with one set of wheels above and one set of wheels below; the location of the wheels creates sufficient friction to grip and drive the rope.
2 Two pairs of wheels one on top of the other the lower wheel holds the rope the upper wheel presses on it creating traction, the lower wheel joins to the rope connected to the container. The rope joined to the container joins to the top of the driving rope and as the driving rope is flexible it can pass over the top of the lower wheel which has a ridge on either side to prevent the rope from moving sideways. Several wheel pairs are used both to spread the weight and created additional traction.
3 The wheels are not joined to motors but hydraulic turbines. The water can then be delivered from a convenient location. Hoses lead to the hydraulic turbines which drive the wheels.
4 Two conveyor belts; one driving the other pressing into the driving belt. The pressing belt prevents the rope from moving. A notch at either end of the conveyor forces the rope into the correct position, the notch sides feature a rotating cylinder or wheel which prevent the rope from being damaged, the rope passes within the notches thus the stretch of rope between the two notches is straight.
5 Pressure exerted by the turning points on the rope creates sufficient force to prevent the ropes and containers from slipping in the same way a pulley does.

### Note.

The weight on the ropes and the spacing bars as well as the rails on the upper frame (used to prevent currents from moving the containers) will prevent the rope from derailing. This type of design is used in ski lifts.

The wheel will comprise bearings, an axle and the wheel. The bearing housing can be joined to the columns and beams of the upper frame.

### Alternative Frames

The lower side beams remain as do the columns but tensioned ropes pass across the middle and hold the upper extractor. Either the lower horizontal beams remain or ropes are also used for the lower extractor (inserter) as well. If no horizontal beams are used the two sides are pulled apart with additional ropes or frame and join to a stable mooring i.e. at least one vertical cylindrical column which descends below the depth of the extractor system.

The remaining frame is buoyant and tethered.

The columns on the extractor are supported by additional ropes and the wheel system frame.

### Truss or Suspension Bridge Frame

The horizontal unsupported beams of the conventional system are long enough to require either a truss or suspension system using ropes.

### OTEC System Platform;

The OTEC systems might not be suitable to place directly into the sea, either they can be given an additional coating and placed on frames into the water or they could be held in a pressure vessel or equal pressure environment.

The ocean thermal system can be held on a frame preferably within a cage with at least one layer of flexible water tight material held around the cage. The inner side of the materials is filled with air to an equal pressure to the sea water depth. A plurality of layers can be sealed to create an air space. External pressures will preferably be absorbed by the air filled layers, in other the words there should be some pliancy in the external material layer to dissipate external fluid pressures caused by currents or waves.

The design requires for the bag to be weighted due to the buoyancy and tethered.

Preferably various aspects will be held on the inside and outside of the membrane, for example it is not preferable to pass water through air inside the bag unless the heat exchangers uses gravity.

### Design;

An equal pressure container made from a concrete base, a metal frame and at least one layer of geo membrane (thin plastic or rubber sheet). The concrete neutralises the buoyancy of the air to a desired amount. Alternatively the required weight to prevent the air chambers from lifting is placed on the sea bottom and a mooring ropes passes up to the buoyant structure.

A secondary ballast system will prevent the platform from sinking if the air is released.

A geo membrane is proposed so that the hardware within can be taken out by opening the membrane. This will allow for the hardware to be taken out easily.

The container will be capable of floating (i.e. is a boat) and will contain variable ballast tanks, preferably designed as the frame buoyancy, (a concrete cylinder with at least one air bag inside and with at least one hole to allow water to pass in and out.)

The thinking behind this is to;

Crucially avoid offshore platform hardware.

Allow for the container to be raised to the surface and serviced in atmospheric conditions, even taken back to a port.

Avoid pumping though air—since the platform is under water, the presence of air is useful as fluids such as the fresh cold water can be sent downwards as opposed to upwards creating additional pressure. This is especially true since the extractor passes cold water from top to bottom.

Safe from storms with the minimum of mooring cable costs.

### Hardware Layout and Parasitic Energy Consumption;

The hardware will be kept in separate containers; the maximum size on a section of hardware in large systems will not be the full size of the delivery system.

OTEC condensers will be kept just below the extractor height preferably within an air space. The pipes leading to the condenser from the extractor should at least partially travel through a sealed air environment (an equal pressure casing). This will help to create useful pressure.

For example water the heat exchanger is held within an air space, and cold water is poured into the top of the heat exchanger with its nose and tail pointing vertically uses gravity to allow water to flow through it. An open area at the bottom of the heat exchanger within the air space (at the end of the condenser) features open sump to encourage the effect of gravity to allow the water to pass through the heat exchanger) where water can pour would then require a pump to evacuate the water out of the air space. As long as the water is evacuated the effect of gravity will be useful. As the cold water is heavier than the surface water it is slightly heavier than the warm sea water in any case. A restriction at the end of the heat exchanger can be designed to regulate the flow rate of the water.

### A Motor Less System;

With these innovations the system can operate without electricity being required on the container, but the use of motors pump and the use of impellors would make the use of motors viable. There are a wide range of triggering mechanisms which could be used and there depth and pressure is not an issue if designed properly. Should the non-motorised system work well there could still be a use for motors in regulating the buoyancy.

### Mass of the Water and Reduced Mass;

The mass the system rope have to hold is undefined as it is unclear what the extent of the mass reduction will be, a 50% reduction should be possible by simply using gasoline. It is also hard to define as it will constantly change. The maximum mass will be 3 kg/m3. The value of reducing the mass will be to lower the cost of the cables by lowering the strength required, preferably so that the cables strength requirement is calculated mainly relative to current energy rather than mass.

The problem with gasoline is that the buoyant effect changes with density so that there is a limit to the amount of gasoline which can be used before the effect is pointless.

The use of compressible air pockets is possible which will allow for some change in the relative buoyancy without automation this air will also act as insulation as it will be fully expanded at the surface. The shape of the sacs should allow for the inner cavity to be compressed without stressing the skin. This buoyancy could be passive or active depending on budget.

The use of ‘Hydraulic’ hoses could keep the skins separate passively or on demand so that a different pressure was created on the outside by creating a small pressure vessel. The hoses would protect the plastic from bending making it strong. By pumping the water out of the hoses the extent of the pressure vessel can be reduced. As the waste cold water descends it will become less effective.

The relative mass of the water changes with height so there need only be a slight change at the sea bottom to reduce the relative mass of the water in the inner container to neutral. An increase in width of 1 cm would make the container quite buoyant. The 1 cm air space is required to keep the containers insulated at the surface.

The use of a pump could be used to compress the air on the upper downward side and remove the water from the hoses to reduce the physical demands on the materials and have complete control over the mass being lifted.

### Cold Water Contamination;

A small number of Pressure vessels to open the waste side of the container to the outsides on the downward journey; these vessels with flush the container of the waste water over 700 metres of vertical travelling. During the early stage of working systems in suitable water temperatures, temperature sensors should be used to give accurate reading of the temperature so that the outlet is perfected.

The container only ever fills with water on the one side of the container so with careful construction the waste side can remain open. As a result the pressure vessels may only need to be 10-20 bar to pass the photic zone. The vessel would open holes and then which would allow water to pass through but would be closed during the extraction period in order to prevent the release of waste cold water.

The waste cold water is useful as negative ballast until the last 300 m of decent where due to the temperature change it would become buoyant. Preferably the flushing of the container will prevent this too. The use of waste cold water will save energy from the lifting of the water, as the waste cold water is only 2 degrees warmer than the fresh cold water.

### Shore Delivery;

Perhaps it will be easiest to use submersible motors and a contractible container but a novel method is described below which will allow for the system to be controlled from a location such as the shore or from a boat etc.

Especially in the case of systems with a limited no of containers as opposed to a ‘complete train’ with only small periods between containers arriving there must be a way of converting flow from a massive burst over a few seconds and a delivery rate suitable for a hose and end system which uses the contents of one container over a period of minutes as opposed to seconds.

The platform extractor features and additional membrane, this membrane creates a double chamber so that a reservoir (the contents of the extractor) can change volume under water. As water is transported to shore the membrane within the extractor compensates for the change in volume by allowing a second fluid to fill the space which is begin created by the water leaving the extractor.

The second layer of water can be contained in a closed cycle. I.e. this fluid is not used it is simply pushed in and out to prevent a vacuum from forming, being held in a bag it is simply pushed in and out of the extractor.

The platform extractor features a weighted or buoyant, in this case weighted membrane. The buoyant membrane of the container forces water into the extractor which lifts the weighted membrane (or a buoyant membrane down). The weighted membrane then forces water into a hose which travels back to shore or to an offshore site. The power of the container membrane must be greater than the membrane of the extractor. Preferably the weighted membrane will deliver water at a desired rate by at least one of;

Falling at a suitable speed;

Being restricted from the shore end.

Waste Cold Water from Shore;

The hose which travels to shore may consist of at least two layers, at least one of the outer layers contains waste cold water which has been pumped back from where ever it is used from. This waste cold water can be used as the second volume of water required for the extractor and (since hoses are being used) at least partially contribute to the flow rate of the extractor (the fluid will push the extractor membrane). Thus the delivery rate can be controlled from shore (or from an offshore site).

Preferably; since an up and down membrane is used in this case waste cold water will be pumped into the extractor from the top and will force the membrane down. Thus the exit for the fresh cold water will be in the lower region of the extractor. The system will feature non return valves; one system of non-return valve(s) for water in and one system for water out.

As each cycle involved the evacuation of what is in this case waste cold water the waste cold water can be used in a useful way and be returned to the container as well. If this is the case a third set of check valves is required and a second extractor as previously mentioned.

It may also be useful for the upper extractor to feature a buoyant membrane for extra power (this membrane is forced down by the shore hose delivering waste cold water and the buoyant membrane therefore pushes up in unison with the container membrane when fresh water arrives). The container membrane forces fluid (fresh cold water) into the extractor and the extractor membrane forces waste cold water into the lower extractor. The extractor membrane is forced down by the waste cold water during the intermediary period between containers releasing their contents into the extractor.

Once the extractor is full of waste cold water and when the following container arrives the waste cold water in the upper extractor (or vice versa) is forced into the lower extractor. Following on from this moment the lower extractor is full and thus the force of water from the shore will not be able to fill this chamber any further, thus it will be able to push the membrane in the upper extractor down. If this system is used (i.e. the use of pumped water from shore) there may be no need for a buoyant or weighted membrane in the extractor.

A similar method comprises a ‘syringe type ‘piston pump with a spring or rubber cold or additional ‘piston pump filled with air’ to allow a single piston to open with water when the pressure from the container and then to move back pushing the water into the hose bound for shore. This piston and membrane could be without weight and the piston feature a double chamber filling with waste cold water to press the fresh cold water fluid into the hoses.

Power from Shore

A hose from shore (or from a boat, barge) or platform delivers water to at least one hydraulic turbine which drives the cables through a system of gears and axles.

### Additional Methods of Opening the Valves

The wings of the container valve have openings to a crude hydraulic system. At least one side of the container wing features and opening, the open leads to a pair of pipes. The outer pipe can pass over the inner pipe. The outer pipe end furthest from the wing opening is sealed. A change in pressure will extend and contract the pair of pipes. A pump in the extractor sucks water from or into the pipes in the extractor which causes them to open or close.The pipes open and close a sliding door.

The opening can be described to be similar to a bath tub with the pipes extending from its side. As the opening passes through the extractor, it passes a sealed trough within the extractor; the sealed trough is connected to at least one pump. The pump sucks water out of the opening which opens the sliding door, once the container has emptied of the cold water, water is pumped into the opening and the doors close.

The extractor contains two modes of pumping; one mode sucks water out, the second pumps water in. The one passing over the other (pressure within the inner of the two tubes pushes the second out or sucks it in).

A single pump can be used to both suck water in (opening doors) and push water out (closing doors).

### A Hose System for Raising Water;

A double layered hose preferably made from EPDM with two layers the outer containing, an air space filled with polyurethane. The proposed system comprises two hoses.

One hose delivers water downwards which turns a hydraulic turbine; the hydraulic turbine drives a shaft which is connected to a pump—preferably centrifugal. Preferably this connection will incorporate gears and at least some of the parts will be made from plastic, for instance the housing, the shaft from titanium. This pump sucks in fluid from and forces it up a hose to the surface.

Once the system is fully operational the downward hose will deliver waste cold water downwards. The downward hose will not release the waste cold water in the location of the cold water intake rather it will send it back up to a higher region of water with a similar temperature or a suitable distance away from the intake.

The intake system will feature at least one ‘trash grid’.

### Alternating Buoyancy System

A container with a buoyancy system comprising; a pressure vessel, (i.e. a diving cylinder) a turbine (impeller), a centrifugal pump and a weighed valve. The weighted valve is either opened or closed depending on which direction the container is travelling in.

The impeller drives the centrifugal pump which compresses air on the downward journey, into a diving cylinder; due to the location of the valve the diving cylinder collects the air. At the beginning of the upward journey the weight valve falls back due to gravity, this allows the air in the cylinder to release the air.

The air is held in the double skin. The fact that the valve is open means that the impeller will not be able to compress the air on the upward journey. Thus there will be a convenient difference between the two sides of the system.

Additional hoses in the double layer can fill or empty with sea water through a centrifugal pump driven by an impeller. The hoses can force the double layer to be larger on the upward travelling side than the downward side.

The use of a diving cylinder can allow for enough air to be stored for the difference in volume between 0 and 20 metres to be compensated for.

### Tail Plane/Stabilisers

At least one of the frame, the rope feature tail planes for stability. The tail planes angle can be mechanically altered or fixed depending on knowledge of the local currents and their consistency. In principle the tail plan can be any large flat surface which is more hydro dynamic to the oncoming current than it is on either side. The tail plane will help resist any twisting and swaying contrary to the direction of the current caused by inertia in the frame and ropes. If the current direction and speed changes the tail plane should be able to alter its own angle. This can be achieved using hydraulics or ropes and pulleys.

### Wings

In order to give the upper frame lift wings/stabilisers can be designed to generate lift using the current.

### Horizontal Movement Stabilisers

Assuming that a catenary moving system is not used rather a vertical rope system; horizontal movement can be reduced by placing flat surfaces at a certain depth in line with the direction of the horizontal movement onto the rope system. Due to the Ekman spiralling effect flat surfaces placed at a certain depth with not be facing the direction of the current at the surface and will resist the forces moving the frame and mooring movement with is in line with the direction of the current in the proximity of the upper frame. Preferably this system will have some degree of manoeuvrability using pulleys or hydraulics and intelligence in the form of current sensors and a computer program to realign the stabilizers height depending on the speed and direction of the current. The effect will be a responsive stabiliser which can alter its position relative to the Ekman spiral and the relative differences in current direction with depth.

### Alternative Position for the Rope Driving System

In order to minimise the effect of horizontal movement on the cables and the driving system the driving system is held on a vertical stretch of rope in deeper water. The upper frame will feature rotating wheels or cylinders. At each end of the upper frame, notches will straighten the ropes. The notches will have horizontal and vertical rotating surfaces so that the rope is not damage due to friction. The extractor double L and the container T form will be fanned and curved to allow a margin of error in the initial moment the two bodies meet.

### Notches

In order for the container rope to pass safely over the notches, the inner side of the notches will feature a slope so that the rope between the container and the driving rope must pass up and over the notch. The slope can be exaggerated to the extent that it is impossible for this part of the system to misalign.

### Novel Louvre Design

Made from a geo membrane, 3 slots cut into membrane to form a flap, additional sheets are welded to the edges so that there is an overlap. Bungee/shock cord is used for restoring force and is fastened to the flap and the surrounding membrane. Additional rigid material can be used to create stiffness in the sides of the membrane.

### Alternative to Catches on the Louvre

The membrane is held by a lever, the lever is pushed back by the extractor on the outside of the container allowing the membrane to rise or fall (if the membrane is weighted rather than buoyant the membrane will fall). The inner side of lever is fitted with a non-return lever (the lever can be broken open to allow the membrane to pass at the end of its movement). The lever comprises a spring and a hinge which can only open in one direction. Once at the surface the lever cannot open until it is pushed back by the extractor.

Preferably a small structure/frame on one side of the membrane is used to catch the lever, and it is the small frame which forces the non-return lever open and which holds the membrane in place. Once the lever is pushed back by the extractor the non-return lever is pushed past the frame and the membrane can rise or fall.

Neutralising some the weight of the water; can be achieved using a buoyant liquid such as gasoline held in pockets within the two layers of skin membranes.

The pockets could also container air, which has been pressurised (like a tire). This will allow the air to act as a stable fluid up to a certain depth and then compress.

### Submersible Tube Heat Exchanger Design

Heat Exchanger Designs Apply to all Ocean Thermal Systems which Use Heat Exchangers.

A submersible heat exchanger with very few welds, the heat exchanger unit has the appearance of a cylinder or streamlined body from the outside. The casing for the heat exchanger is preferably made from plastic.

Ammonia is typically used in the OTEC closed cycle systems but these designs can apply to any refrigerant working fluid.

Within the unit lie straight or coiled tubes.

Only the ends of the tubes are welded to a metal sheet behind a plastic façade. The tubes pass through the plastic and an extrusion weld is used to seal the plastic to the tubes separating the metal weld from the interface sections.

The interface section exposes the outside of the tubes to cold or warm sea water. Sea water is pumped through the units.

The aluminium tubes can be welded to the sheet using Dura fix or a similar product. The use of Dura fix will allow for the weld to be broken by reheating the weld without destruction to the tubes due to a different melting point. Thus the joining areas can easily be replaced. In principle the seal made by the plastic will prevent corrosion to the joints because the weld area will not be exposed to sea water but if the joints do corrode they can be replaced.

Preferably the ends of the tubes are joined to hoses capable of transporting ammonia. Alternatively the ends of the tubes are held in a pressure vessel and the pressure vessel is joined to the ammonia transport tubes. Two units can be joined so that ammonia passes up then down or vice versa.

Cold water/warm water can be pumped down up or across. Flanges joined to the interface container join water delivery and extraction hoses to the unit. Pumps can be contained in the upper or lower region of the cylinder.

If the water is pumped across; additional partitions can be made within the container to support the tubes by placing additional plastic boards within the interface chamber. These boards can be pre-made with holes to pass the tubes though and additional holes to allow water to pass if required.

If the water passes in the same direction as the tubes i.e. top to bottom the container will widen at its top and bottom to accommodate the volumes of water, e.g. the heat exchanger tubes combined create an area of 1 m2 main interface unit is approximately 1 m2. But the ends of the unit are 1.25 m2.

Location of the unit; to the sides of the delivery system, each unit is held by its bottom to a rope which may only descend to a horizontal rope (which holds a plurality of heat exchangers) as opposed to the sea bottom, the units are held by ropes preferably with a catenary mooring between each unit and at least one other.

X no of heat exchangers are connected to a single turbine unit which is also cased in plastic and which can be container in a similar underwater buoy or in an single point mooring and unit at the surface (similar to those use to moor oil tankers).

The casing for the heat exchanger will preferably contain buoyancy at the top and bottom and act like a pile/single buoy mooring. If the casing is a streamlined body the body should be able to rotate. Each cylinder unit can be readily disconnected and replaced or serviced.

The location of the units allows for the combined effect of the catenary mooring to reduce the movement of the delivery system platform and to act as a current break.

Alternative metals to aluminium can be used for greater detailing.

The layout of the system can be reversed so that ammonia travels horizontal and the water vertically.

### Heat Exchangers Design Two;

### For Evaporators and Condensers;

As above but with the following differences;

The tube ends are placed through rubber or plastic end attachment similar to a ‘cable entry sleeves’ or ‘flanged bushes’. Preferably the cable entry sleeves will have been heat welded or glued onto an additional flat sheet of such as epdm (or preferably the Perlast elastomer product) so that the plurality of sleeves have become one piece. Preferably the attachments would be capable of gripping the tube due to a slight difference in diameter so that the attachment stretches a little. The attachment will preferably be glued to the tubes using a suitable adhesive. Rather than producing the attachments and said flat piece of rubber as separate entities the two parts would preferably be produced as a single item.

The rubber/plastic attachments are held between two sheets of rigid plastic (such as HDPE or PTFE) both of which will be perforated to all the tubes to pass through. The plastic will preferably be produced in such a way that its shape will optimise gas flow efficiency and ease of production.

A gasket with flange would be placed over the gas side to seal the chamber.

### Sealing Preferences

Preferably the Perlast fitting would grip the tubes sufficiently for the tube to be sealed, if not adhesive sealant could be used around the ends.

### Heat Exchangers Preferences

The tubes are spaced apart within the heat exchanger but on the outside the tubes can be bent inwards and fastened closer together than there are on the ‘ tube sheet’ to lower the area the tubes take up.

The heat exchanger uses side flow.

The baffles help to hold/support the pipes if side flow is used the heat exchanger does not require the water to pass through the baffles. Therefore these baffles can be sealed using an extrusion weld if this helps support the tubes.

Additional layers of plastic can ensure there is no ammonia leak and protect the cable entry sleeves from chlorine or any other anti-bio fouling technique. The sides of the heat exchanger can be heat welded to the baffles and to the plastic sheets at the ends.

### Cold and Warm Water Flows

Preferably due to the large volume of water the heat exchanger pumps will use propeller pumps. The opening to the heat exchanger for the cold or warm water will be larger than a usual heat exchanger.

### Different Numbers of Pipes as the Working Fluid Expands or Contracts;

The heat exchanger pipes/tubes pass into a partitioned section (the section is sealed to prevent working fluid leak) which contain a different no of pipes on each side. The tubes use the ‘cable entry sleeves’ to create a seal.

In the condensers the no of tubes decreases as the fluid passes through said partition. I.e. the fluid passes from 700 tubes on one side to 500 on the other.

In the evaporator the no. of tubes increases.

### Adjustable Ends for Easy R and D and to Compensate for Seasonal Temperature Differences:

The inside ends of the heat exchangers can be fitted with adjustable sheets of plastic to change the amount of tube expose to the warm or cold fluid. The area behind the façade can be filled with air (preferably pressurised to water depth) or removable polyurethane or the like to prevent a void. The same cable entry sleeves with crocodile clips can be used to seal off this area if air is used. Insulation can be added and removed from the sides of the heat exchanger. A fluid with a very low delta T compared with working fluid temperature the inside of the pipes can be created and added consistently to this region. Alternatively a cavity around the outside of the container can be filled fresh or waste cold water is pumped to prevent warming but with the inner region filled with air or foam for a very low heat transfer rate.

### Consequences

No metal welding is required.

Pressure/temperature drop control.

### Preheater

As the system is underwater the ammonia can be preheated by the sea water using a simple pipe between the condenser and the evaporator to preheat the ammonia. The pipe can feature ‘fire rods’ on the inside and any other know innovations to increase ammonia turbulence and heat exchange rate.

The extent to which the entirety of a metal pipe is exposed can be regulated by covering it with at least one of, an adjustable, bag, sheath, sheet, hose etc.

If a hose or sheath is used, with the sheath placed over the pipe, chlorine can be added periodically to remove bio fouling. The chlorine then removed and the sheath would then be pulled back to re-expose the pipe.

### Turbo Generator Held in Equal Pressure or Pressurised Preferably Plastic ‘Tank’

In order to prevent ammonia leak a turbo generator can be installed in a plastic tank preferably pressurised to the level of the system for example 10 bar ideally just below the system pressure. The tank may be split into two sealed sections with a different pressure rating for the post turbine aspect.

All parts would preferably be removable with the tank preferably made from HDPE.

### Buoyancy Drive

If the containers can be fitted with a buoyancy drive or propulsion turbines the containers can pass along the ropes or pull them. The buoyancy drive or turbine drive can be powered by batteries, hydrogen, diesel/biodiesel etc.

A robot can add and replace an energy source to at least one container. For example a robotic arm can add and remove a battery from its location on the container.

A conveyor belt with a retractable hose can add Hydrogen to a tank on a container.

The extractor and container can feature metal surfaces so that the containers can charge with electricity with the use of a battery. When the container is in contact with the extractor the two objects form a circuit and a battery in the container can be charged. The use of a circuit between the extractor and the container could be used provide electricity to compress air.

Preferably the circuit will be held in the wings on the container and the adjacent aspects of the extractor.

A robotic arm or conveyor may have a magnet to attach itself to a battery; the container may also feature a magnet or a catch. The magnet on the arm can be turned off to allow the battery to be released once it is held in place by the container.

An insulated tube joined to the containers runs passes along (and covers) a cable capable of transmitting electricity to the containers. The tube covers the cable so that it does not electrify the surrounding ocean. As the tube passes the join between the cable and the power supply, a small cut away section along the side of the tube allows it to pass. This passing point can be contained within a chamber. The moving tube passes through a seal which prevent exposure of the cable to water, excess water can be pumped out and the container can be insulated.

An umbilical cord provides power to at least one container the remaining containers can be joined by cables running between the containers.

### Buoyancy Drives

A weighted piston and chamber filled with air; the weighted piston is neutralised by a fluid such as gasoline (located on the same container) so the net weight of the container due to the piston is for instance actually zero. On the decent the weight of the piston compresses the piston chamber as the container turns around the weighted piston falls back decompressing the chamber. Depending on the extent of the weight relative to the volume of the chamber the effect of the increased pressure will vary.

### Closed Cycle Containers

A closed cycle container with metal or glass sheets replacing some of the container sides. The container holds potable water or any other non-corrosive liquid. This system is suitable for up and down two way systems or one way system with multiple containers

1. The sheets are exposed and covered using a pressurised piston designed to open a suitable depth. The pressure of the sea water forces a piston back due to the air compression the piston pulls back an insulating sheet exposing the surface area.
2. Alternatively a motor can be used to expose the surfaces.
3. In the case of a one way system; the pressure piston (catch) can release a weighted or buoyant cover at the desired depth, due to the pressure the piston moves back leaving its connection with the cover so that it no longer prevents the covers from falling.

The cover falls down (or rises up) revealing the heat exchange surfaces, as the container turns heading upwards the cover falls back (or rises up) covering the heat exchange surfaces. The piston moves back at a certain depth, and as it extends it locks the cover in place.

The cover must be insulated.

The inside of the container contains a pumping system which can be powered using a propeller connected to a centrifugal pump. This pump circulates the fluid.

Consequentially the cold water heat exchangers at the surface will not be exposed to corrosive sea water, thus the design may be detailed and use very thin walls.

The same method can be used for the warm water but no exposure system is required.

Due to the difference in time exposed to cold environment the heat exchange surface on the container can be simple and safe in the event of corrosion it can easily be replaced.

### A Single Complete Module

A single cylinder contains the heat exchangers and turbine. The warm heat exchanger is located at the bottom with the turbine in the middle, the Turbine passes the gas on the outside (or through a cavity filled with pure water) of the cylinder through tubes so that the ammonia gas is passing through water, the cooled working fluid, passes down though tubes within an air cavity to the warm heat exchanger.

The purpose is to reduce the pressure drop due to friction as the two fluids will either be positively buoyant or negatively buoyant due to the surrounding fluid.

The heat exchangers can either be immersed in a fluid, or held within an air cavity.

### A Coating for the Ropes;

A single rope or more than one rope can be held within a geo membrane for instance an HDPE membrane or some another suitable fabric creating a belt. The belt protects the rope and creates a convenient surface for a wheel or plurality of wheels to drive the belt. The belt can be fitted with additional grip in the form of a high grip rubber which is preferably replaceable.

Driving Ropes can be completely replaced with a belt made from rubber plastic or nylon.

### System Used for Aquaculture

Rather than delivering to an OTEC system the extractor delivers the water to aquaculture pens, preferably the pens are under water and can mix surface water with cold water, whilst preventing discharge of the nutrient water. Preferably this system will be used to grow a variety of organisms on a variety of trophic levels.

### A Mooring System for Systems on a Flat or Steep Shelf;

A single rope which; in the case of a steep shelf, is tethered to the sea bottom in shallow water. This rope passes down to; for example, −1050 m. Either from a single point a second single rope is passed up, say 5 metres or a plurality of ropes are passed up. From this point perhaps 4 ropes 2 on either side of what will be at least the container width. A Buoyant frame (frame with stored buoyancy) holds these ropes apart. These ropes ascend to the surface and some of these ropes join to the extractor frame, whilst others may be joined to a buoyant structure which may or may not be joined to the extractor frame. The frame may hold the turning points or the turning points are held on the ropes separately so that they can be moved.

The use of; slings, chains, cables, pulleys, any suitable type of chain, or cables fastenings can be used where useful for example to join a pair of ropes. A person skilled in the trade of anchors, chains, ropes and their respective connection systems can advise.

Alternatively the turning points are lowered. With the each turning point held by a pair of ropes the turning point can travel up and down along the rope pair; a for perfect height and b for maintenance.

The turning point can be moved up and down with the use of at least one rope held in a loop joined to the turning point, preferably at the upper and lower end so that the turning point can be pulled up and down.

Alternatives include that the turning point is weighted or buoyant which would allow for the turning point to join to a single rope rather than a loop.

The single rope joint (means of allowing a vertical rope from a rope traveling at an angle other than horizontal to the sea surface), comprises a looped rope or nylon sling, joined to the cable and a second looped rope joined to the first. Alternatively a chain can be used. These items can be protected within an HDPE sheath.

On a flat sea bottom the same principle can be used without the shallow rope mooring.

The lowered turning points can be adjusted and markings on the winch rope of the turning point can denote the precise height of the wheel below.

### Installation

‘Rough anchors’ sent to the sea bottom with rope and buoys at the surface are lowered. The ends of the system proper are lowered slowly done the ‘rough anchor’ ropes. E.g. if the delivery system is 20 metres long the anchor buoys will be placed 25 metres from one another. The rope system is lowered in between the rough anchors and then the upper frame and turning points are joined to the ropes.

### A Few Pipe Designs;

A plurality of pipe sections each with a flange (cylindrical sections) are joined together over a large rubber section, the rubber section allows for the pipe to be slightly flexible. The pipe weight can be neutralised or a material such as HDPE used.

### Closed Cycle Hydraulic Turbine to Drive Cables;

The hydraulic turbine uses a closed cycle low corrosion/zero fouling fluid, driven by a pump. The closed cycle will preferably feature a reservoir which features a contractible section, i.e. a bag or a piston to allow for changes in volume.

Conveyor System with Rope Lock;

A conveyor system for driving the ropes; two conveyor belts are placed over a rope; the belts have a specific depth (due to a raised solid section on either side of the belt e.g. a rail) of approximately one third the diameter of the rope. Thus there is approximately one third of the middle section of the rope exposed to the sides. A second thinner rope or bar is joined from the trapped rope to the container. This rope must be ⅓ the diameter of the driven rope in this example.

In effect the driven rope is trapped between the two belts and the linking rope/bar between the driven rope and the container can pass through because the linking rope is thinner. This system will prevent ropes from ‘derailing’.

Additional cushioning for the ropes and guidance systems for both ropes can be provided. For example and HDPE sheath and at least one pair of rails with differing distances between each rail to allow the rope to be shepherded into the right position form a range of additional locations. Examples of this system can be seen on cable car end stations.

Preferably the convey belts will have no moving parts. For example; using an HDPE membrane and metal tubes rather than any rotational parts; the belt slides over the tubes. Either the ropes simply slide on the HDPE surface (the HDPE surface doesn't move at all) or the HDPE surface moves as a belt.

### Manually Adjustable Buoyancy Control Device for Each Container.

Each container is fitted with an adjustable air chamber, air con be added and removed and then left permanently in place. The effect will be a neutral buoyancy of the container as it moves through the extraction system.

### Pneumatic Membrane System.

Rather than using weights or buoyancy to move the membrane; compressible air chambers (chamber and piston) are compressed on the downward journey. The membrane is joined to the piston and so the increasing pressure of the downward journey forces the piston closed this forces water out of the container. The piston canbe pressurised to prevent compression until a specific depth.

The piston is trapped by a catch which prevents the piston from opening on the ascent. At the surface the right moment the catch is released and the piston expands forced the membrane to move expelling the water. The piston can be articulated (comprising more than one member) can that a plurality of piston member fit into a smaller space.

### The Use of a Spring or Rubber Band to Store Energy;

An air chamber with a piston; as the container descends the piston is restricted from moving by the spring or rubber band, eventually the chamber is compressed and the piston is locked until it reaches the surface where the catch is released releasing the piston, the piston can be used for work, for example forcing a second air chamber to be compressed by the expanding piston. This would alter the buoyancy of a container.

As container is descending compressing air chamber can be used for work catches can be used to trigger the release of the piston.

### Natural Forces Barrier

A piece of cloth fitted (preferably water/air tight nylon) with buoyant air sacs is preferably held on a separate set of ropes from the main system.

Alternatively a plurality of sealed cloth sheets form a single sheet, air pockets are created between the sheets.

The cloth is placed in the way of current and wave forces.

Preferably there may be some spaces in the sheet.

The sides of the cloth can be held using buoyant float and bungee cords.

Other options include a mesh with stored buoyancy.

This concept can used to form a buoyant canopy above and to the sides of critical hardware. Sheets with no holes in can be used to create air pockets.

Suitable shapes used in tent design are applicable.

Rigidity and shape can be created using poles similar to those in tents.

### Anchors

A large flat surface can be held at depth below water current activity. The anchor can be weighted. For example a geo membrane filled with sand.

### Spring or Rubber Loaded Bar;

A single louvre flap system with a spring or rubber band loaded bar placed over the louvre flaps. The bar or the like exerts a force on the flaps keeping them closed. When there is no pressure the bar keep the flap closed. The bar is forced up or down by pressure on the flaps which forces the bar up. When pressure ceases; the loaded bar forces the flaps down.

An additional bar (member) fixed in placed to a desired height above or below the flaps prevents the flaps from opening too far.

The loaded bar can be prevented from moving around in an undesired way by adding rails at each end of the bar.

Extractor Container with Ports for Additional Heat Exchanger;

An extractor container is built with ports for more system than may be installed at any one time. The port either holds a plug or a heat exchanger. Alternatively the heat exchanger is placed within the extractor, the pumping system would pull water through the heat exchanger to the waste container rather than pumping to the heat exchanger.

### Tensioning System.

The turning points may be susceptible to wave motion, There are several ways to reduce the effect especially if the rope driving system requires for the ropes to be held in tension on all turning points at all times.
1. The turning point contains stored buoyancy separate from the upper buoyancy.
2. The turning point is fixed to a buoyant pile.
3. The turning point is fixed to a rope which passes up and through a pulley the rope then passes back down and is attached to a weight. Should the upper end of the ropes which are held up by buoyancy move downward the weighted rope would fall instantly holding the turning point up as a result.

### Maintenance

A situation might arise where a turning point requires maintenance; in order to prevent difficulties;
A. A Frame which is permanently a part of the system holds rope in absence of turning points; frame is fitted with grooves or notches to hold rope.
B. A pulley system transports a bar to one side of the turning point which holds the rope in place as though it were a turning point. Grooves in the bar trap the rope in a specific location before the turning point is raised so that the rope remains in the same location. The groove spacing on the bar will preferably be less than the spacing on the turning point. A bar with at least one groove with the grooves capable of being moved from the surface with the use of a rope and pulley or robot would also help.
C. There are more than enough turning points for the rope to be held in position, each turning point is raised and replaced etc. the remaining turning points hold the rope in place.

### Conveyor Belt

A conveyor belt or chain rather than a rope is used to transport the containers.

### A Single Bar Turning Point.

The lower turning points are essentially bars with or without rotating tubular surfaces; the surface will preferably be sloped. As there is a single rotating surface the rope could not derail. A slight deviation from this design would involve the single bar having an elevated surface to allow the container valve to pass.

### A Compressive Conveyor

A conveyor system for driving the rope features at least one conveyor with a second conveyor or at least one wheel used for creating pressure on the driven rope. Preferably the conveyor comprises a belt and a plurality of rollers. Alternatively a pair of conveyors; one with the rope on it the other pressing into the belt and rope, preferably the pressing conveyor is adjustable with the use of at least one of; a pneumatic or hydraulic system, a pulley or weight. If a pair of roller conveyors are used at least one wheel driven by a chain and motor or a roller conveyor motor would be used to drive at least one of the upper or lower conveyor. Other methods of propulsion include a submersible water pump and a pelton turbine to drive at least one wheel with or without a chain.

A gravity roller conveyor is generally constructed so that the roller on one side is some distance below the rails (‘roller frame’/‘side supports’/‘roller and bearing support frame’) on which it is mounted and higher that the sides on the other. The roller frame would help to prevent the rope from derailing to the sides and so a suitable attachment which would allow a pair of conveyors to drive a rope and allow the container to driven rope attachment to pass without losing compression or breaking would be advantageous. With sufficient pressure on the rope the rope system would not be vulnerable to changes in tension throughout the rope system.

### Rope Attachment and Container Joint;

The attachment can be constructed in the same way as a detachable gondola attachment is, a person knowledgeable in the design of such catches may advise, preferably the catch would be L shaped with the driven rope held in the lower horizontal portion of the L, a second plate would hold the rope or a spring or catch. The purpose of the L shape would be to allow the catch to pass through the conveyor to the height of the vertical element of the L with the container attachment (preferably a tube with is joined to the container through a bearing so that it can rotate) passing from the uppermost portion of the L horizontally across to the container, and for the second conveyor or wheel to pass over the horizontal section of the L in such a way that it would be pressed into the lower conveyor with very little change in position from when the rope is being driven in the absence of the container attachment. The L attachment may feature a sloped front so that it moves smoothly onto the rollers. Additional guidance for the container bar and or container and rope can be added to ensure the system functions properly.

A pneumatic upper conveyor or a compressible wheel or belt of the upper conveyor and an upper conveyor which can fit inside the lower conveyor or a system wherein the wheel of said conveyor can fit inside the walls of the lower conveyor would be preferable.

### Extractor System Incorporating PU Foam Inserts;

The/any, space between the rails (between the extractor container valve) can be filled with flexible PU foam the container vent rails can pass between a pair of foam ‘sheets’. This will grant a larger lee way and is easy to construct. Either the container valve or the extractor can use the PU foam, preferably one or the other.

### Container Supported and Joined to Ropes by Rigid Bar

In order to make a smooth glide the container will use a rigid bar preferably at the nose and tail to join to the ropes.

Flaps and Vents with Magnetic Seal and Preferably Electronic Sensors;

The flaps/vents of the system will preferably be fitted with magnetic seals to prevent leakage, electronic sensors and electromagnets would preferably be used, the sensor would permit the opening of the vent at the right moment.

### Gills

Assuming the vents leak a little at least one sheet of plastic with slits cut into it would help to prevent circulation with in the container. These slits would prevent water motion in or out of the container without the force of the membrane.

### Alternative Two Way Extractor Valve

A two way vent comprising a flat piece of material preferably joined to a tube which passes through the middle of the section. The tube contains a round section so that between the tube and the round there is the potential for rotation. The round section (′round′ is a piece of non-hollow circular tubing) passes to the side of the flat section and into an additional piece of tube and flat at each side (preferably on both of the shorter sides of the original rectangular section), to create fixed rotation. At each side of the longer sides (preferably both sides) of the original flat piece of material additional flat sections are placed onto the longer sides in such a way as they overlap so that 50% of this piece is laying on an additional flat piece of material when the valve is closed and so that the valve will only open in one direction. One of these flat pieces will be placed on the upper side of the original flat section the other will be on the lower. This will allow each side of the flat section to open in one direction but will allow two way flow, the side pieces help create a seal as well. The additional pieces of material on all sides create a complete valve with a seal and allow rotation. This creates a rotating flap with two directional responsiveness to pressurised fluids; e.g. the pressure generated by the weighted membrane.

Additional features or alternatives include the replacement of the tube for holes drilled into the sides of the original flat section, grooves for increased fluid flow cut into the original flat piece of material, a deliberate slight misalignment of the hinge so that there is an opening bias, and the use of additional pieces of rubber fixed in the vicinity of the seal area to help create a better seal. Preferably the flaps will be mechanised by placing a bungee cord through a tube which is pulled by a stretched bungee cord down onto the/a plurality of rotatable flaps to form a seal with pressure. This use of a bungee lowers foreseen maintenance issues in relation to springs and salt water but springs or rubber bands could be used. The rotating section can be prevented from opening too far by either preventing the original flat section or the tube with bungee insert from moving passed a certain point. This can be done by placing at least one fixed section/member in the vicinity of the flaps in such a way that the flaps are prevented from moving passed a certain point by the fixed section (s). This point will likely be above one side of the rotating flaps in a position which is lower than the maximum height of the side of the original flat section were it to be opened to the extent that it were at a right angle from its original closed position. Using this principle there is no way the flap can remain accidentally open.

### A Cable Maintenance Concept.

In order to save time when one of the drive cables needs replacing the container to cable mechanism described above would be capable of holding a second cable on each side. Thus the container system could join a new cable to an operational system by fixing the cable to the ‘auxiliary’ attachment point of the container to cable mechanism. As each container passed the new rope would gradually be attached to the system. Once the new rope was successfully supporting the system the old rope could be removed. The container to cable attachment mechanism would probably have a spring mechanism or a ‘Jack’ (i.e. The device used to lift cars) or similar inbuilt power mechanism to generating sufficient grip between the attachment device and the rope.

A Turning Point with a Plurality of Conveyor Systems on Each Side.

So as to provide a very stable turning point system, each side of a turning point features two conveyors, with at least two ropes on each one. The resulting container attachment would be much larger than the covering levers (the levers used to prevent derailing mentioned above) so that derailing was impossible and also much stronger.

### Some Proposed Methods of Installing Large Numbers of Containers.

FIG. 1 is a schematic diagram of a system for raising water using containers at a first stage of installation, in accordance with a first exemplary embodiment of the present disclosure. FIG. 2 is a schematic diagram of a system for raising water using containers at a second stage of installation, in accordance with the first exemplary embodiment of the present disclosure. FIG. 3 is a schematic diagram of a system for raising water using containers at a third stage of installation, in accordance with the first exemplary embodiment of the present disclosure. FIG. 4 is an isometric detailed view illustration of a system for raising water using containers at a first stage of installation, in accordance with the first exemplary embodiment of the present disclosure. FIG. 5 is a front view illustration of a system for raising water using containers at a completed installation stage, in accordance with the first exemplary embodiment of the present disclosure.

With reference to FIGS. 1-5, the system for raising water using containers 10 includes a first frame 20 which is ascendable and descendible within a body of water 12. At least one container 30 is connected to an elongated cable 40, wherein the elongated cable 40 is connected to the first frame 20. Two free ends 42 of the elongated cable 40 are connectable together when the first frame 20 is in a descended position within the body of water 12. As described herein, the first frame 20 may be considered a lower frame which is positioned wholly within the body of water 12 and moveable between ascended and descended positions. The first frame 20 may be connected to at least one anchoring cable 50 which is connected to at least one mooring device 52 positioned on a lower end of the at least one anchoring cable 50. The first frame 20 can be moved between the ascended and descended positions within the body of water on the at least one anchoring cable 50.

In addition to the first frame 20, it is noted that the system 10 may include a second frame 60, which may be understood as an upper frame. The second frame 60 may be positioned substantially vertical to the first frame 20 and positioned proximate to the surface of the body of water 12. In some situations, the second frame 60 may be positioned at or slightly above the surface of the body of water 12 and then lowered to a position below the surface of the body of water 12. For example, the second frame 60 may be positioned a few feet to tens of feet below the surface of the body of water 12 yet still remain vertically above the first frame 20. The first frame 20 may be ascendable and descendible within the body of water 12 using at least one of: a weight; and a pulley. For example, in FIG. 1, the first frame 20 may be ascendable and descendible from the second frame 60 using a winch system 70 which includes a plurality of weights and pulleys.

As is shown in FIG. 1, the first frame 20 may be positioned in a substantially raised position at a first stage of container installation with the elongated cable 40 and containers 30 connected thereto. When the first frame 20 is in the ascended position, the at least one container 30 may be positioned proximate to a surface of the body of water 12. FIG. 4 also illustrates the first frame 20 positioned proximate to the second frame 60, in an early stage of container installation. Then, as shown in FIG. 2, the first frame 20 may be lowered to a partially descended position. In this position, the elongated cable 40 and containers 30 may remain attached to the first frame 20 and be positioned to either side of the first frame 20. Next, with the first frame 20 in the descended position within the body of water 12, the two free ends 42 of the elongated cable 40 are connected together to form a loop of the at least one container 30, or plurality of containers 30, on the elongated cable 40.

Other variations of the system 10 may also be employed, especially in situations where a large number of containers 30 are used. For example, assuming a system 10 utilized one-hundred or more containers 30, all of these containers 30 could be joined to the elongated cables 40, e.g., driving ropes, at the surface, as shown in FIG. 1. Once the turning points on the driving ropes, i.e., the positions on the elongated cables 40 where the cable turns to the first frame 20, are in the right position, a portion of the elongated cable 40 would be trapped into the lower turning points, i.e., the portion positioned proximate to each side of the first frame 20. The use of electro magnets might prove more efficient than pulley and ropes to support the derailing levers. If electro magnets were used the magnets would prevent the derailing lever from opening. In any case the elongated cable 40 is secured to the lower turning points as it would be when operational, i.e. unable to derail but capable of low friction movement. The turning points are then lowered. As a result all 100 containers 30 are pulled beneath the surface in a single process. In order for container 30 not to have to be dragged down with the container 30 positioned horizontal with the surface, a gap in the elongated cable 40 could be left by omitting containers 30, as is shown best in FIG. 5. Otherwise, it is possible for these containers 30 to have substantial negative buoyancy stored in such a way that it could be removed. If containers 30 are omitted, this would mean that several containers 30 would have to be installed later with the use of divers and pulleys. Alternatively the lower most containers (the containers 30 closest together at the surface) could have their skins removed partially or fully so as to reduce the drag.

Preferably the container would be naturally just a little positively buoyant, neutrally buoyant or just a little heavy so that they sink slowly of their own accord. In order for this to be possible the container would be capable for storing buoyant inserts, such as HDPE bottles or tanks which could be conveniently removed at the surface prior to the sinking of the 100 containers. The buoyant insert may control a buoyancy of the at least one container 30, as is shown in some of the containers 30 of FIGS. 1-3 for clarity.

As the turning points are lowered the two outer most ends of the string of containers 30 are pulled closer together and then pulled under. Since there is a horizontal element at the top and bottom, the elongated cable 40 could either be a little longer than the depth or some containers would be missing from the string i.e. there would ideally be 110 containers 30 using the above example of 100 containers. If containers 30 are missing from the elongated cable 40, the remaining containers 30 at the surface would not have to be flipped over for the ends of the elongated cable 40 to be joined together. In any case with the majority of containers 30 submerged and in the right position the end of the elongated cable 40 are joined together. The remaining containers 30 are joined one by one with the use of pulleys and commercial divers. A variation on this theme would be that the containers 30 are not all joined at the surface they are added one by one above sea level and pulled under, one by. In the event of a storm or unexpected swell height it would not take long to safely submerge all of the containers 30.

Alternatively with the majority of containers 30 in place, with the upper most container 30 submerged in with its nose pointing upwards, the elongated cables 40 are folded over and the remaining containers 30 are joined to the ropes. It may not be possible to join these elongated cables 40 at the surface unless the turning point is an appropriate depth higher than it would be in operation. Assuming it is higher the elongated cables 40 could be joined and the lower turning points lower further so as to pull the containers 30 to the right depth. The upper turning point could be joined last and preferably the extractor would have been joined to the containers 30 or is/was in position are the right depth.

As is shown in FIG. 3, an extractor 80 may be included to extract water retrieved from the containers 30, the use of such an extractor 80 being described in commonly owned applications. The upper side of the extractor 80 may be removable that if it were at the right depth and the containers were pulled down onto it the upper part of the extractor would not get in the way.

FIG. 6 is a flowchart 100 illustrating a method of installing containers in a system for raising water, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, at least one container is connected to an elongated cable. The elongated cable is connected to a first frame, wherein the first frame is ascendable and descendible within a body of water (block 104). The first frame is moved from an ascended position to a descended position, wherein the at least one container on the elongated cable is descended within the body of water (block 106). Two free ends of the elongated cable are connected together (block 108).

FIG. 7 is a flowchart 200 illustrating a method of installing containers in an Ocean Thermal Energy Conversion (OTEC), Low-Temperature Thermal Desalination (LLTD), or Seawater Air Conditioning (SWAC) systems, in accordance with the first exemplary embodiment of the present disclosure.

As is shown by block 202, at least one container is connected to an elongated cable. The elongated cable is connected to a first frame, wherein the first frame is ascendable and descendible within a body of water (block 204). The first frame is moved from an ascended position to a descended position, wherein the at least one container on the elongated cable is descended within the body of water (block 206). Two free ends of the elongated cable are connected together (block 208).

### Container Decent Control System (for Installation Purposes)

Additional mooring points at each end of the system would be moored to the sea bottom these would preferably take the form of a single point mooring system (SPM). The SPM would be fitted with a winch and pulley system so that the decent of the containers would be controlled. Preferably there would be two SPM's at each end of the system. The SPM could container a decompression chamber and divers' air compressor for regular diving without the need for hired platforms

### Modular Multi Low Power Unit Systems

The use of relatively small mass produced alternator and turbine units may be preferable but locating hundreds of single modular unit would become a problem. Rather than increasing scale, a plurality (say 10) of units of, say, 100 kw each would be held together on a single frame. Preferably the heat exchangers would be fixable to the upper and lower regions of the frame with the alternators and turbines placed in the middle. Each unit would be easily removable and accessible and the entire unit could be manoeuvred as a single entity if required.

### An SPM Control Unit.

An SPM with contain the controls for the system so that they are conveniently located at the surface. Alternatively the system can be controlled telemetrically or with the use of an Ethernet cable or both i.e. local and distant control. This SPM can also feature a pulley joined to a lower section of its mooring tether rope so that it can be pulled under the water prior to a severe storm or for maritime safety.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1-4. (canceled)

5. A system for raising water using containers, the system comprising:
a first frame ascendable and descendible within a body of water; and
at least one container connected to an elongated cable, wherein the elongated cable is connected to the first frame, wherein two free ends of the elongated cable are connectable together when the first frame is in a descended position within the body of water.

6. The system of claim 1, further comprising at least one anchoring cable, wherein the first frame is ascendable and descendible within the body of water on the at least one anchoring cable.

7. The system of claim 6, further comprising at least one mooring device positioned on a lower end of the at least one anchoring cable.

8. The system of claim 1, wherein when the first frame is in an ascended position, the at least one container is positioned proximate to a surface of the body of water.

9. The system of claim 1, further comprising at least one buoyant insert within the at least one container, wherein the at least one buoyant insert controls a buoyancy of the at least one container.

10. The system of claim 9, wherein the at least one container is neutrally buoyant.

11. The system of claim 9, wherein the at least one container is positively buoyant.

12. The system of claim 9, wherein the at least one container is negatively buoyant.

13. The system of claim 1, further comprising a second frame positioned substantially vertical to the first frame, wherein the first frame is positioned proximate to the surface of the body of water.

14. The system of claim 1, wherein when the first frame is in the descended position within the body of water, the two free ends of the elongated cable are connectable together to form a loop of the at least one container on the elongated cable.

15. The system of claim 1, wherein the first frame is ascendable and descendible within the body of water using at least one of: a weight; and a pulley.

16. A method of installing containers in a system for raising water, the method comprising:
connecting at least one container to an elongated cable;
connecting the elongated cable to a first frame, wherein the first frame ascendable and descendible within a body of water;
moving the first frame from an ascended position to a descended position, wherein the at least one container on the elongated cable is descended within the body of water; and
connecting two free ends of the elongated cable together.

17. The method of claim 16, wherein connecting the two free ends of the elongated cable together further comprises forming a loop of the at least one container on the elongated cable.

18. The method of claim 17, wherein the loop of the at least one container on the elongated cable further comprises at least one lower turning point and at least one upper turning point.

19. The method of claim 16, further comprising connecting the at least one container to the elongated cable after moving the first frame from the ascended position to the descended position.

20. The method of claim 16, further comprising connecting the two free ends of the elongated cable together prior to moving the first frame to an operational descended position.

21. The method of claim 16, further comprising controlling a buoyancy of the at least one container with at least one buoyant insert.

22. The method of claim 12, wherein moving the first frame from the ascended position to the descended position further comprises moving the first frame along at least one anchoring cable, wherein the at least one anchoring cable is moored to a floor of the body of water with at least one mooring device.

23. The method of claim 22, further comprising a second frame, wherein the second frame is positioned substantially vertical to the first frame and connected to the at least one anchoring cable, wherein the first frame is positioned proximate to the surface of the body of water.

24. A method of installing containers in an Ocean Thermal Energy Conversion (OTEC), Low-Temperature Thermal Desalination (LLTD), or Seawater Air Conditioning (SWAC) systems, the method comprising:
connecting at least one container to an elongated cable;
connecting the elongated cable to a first frame, wherein the first frame ascendable and descendible within a body of water;
moving the first frame from an ascended position to a descended position, wherein the at least one container on the elongated cable is descended within the body of water; and
connecting two free ends of the elongated cable together.
